(19) United States
(12) Patent Application Publication
(10) Pub. No.: US 2023/0140129 A1
(43) Pub. Date: May 4, 2023

(54) THERMAL BATTERY

(71) Applicant: Curtin University, Bentley, Western Australia (AU)

(72) Inventors: Mark Peter Paskevicius, Ferndale, Western Australia (AU); Kasper Trans Møller, Viby J (DK); Craig Edward Buckley, South Lake, Western Australia (AU)

(21) Appl. No.: 17/786,674

(22) PCT Filed: Dec. 18, 2020
(86) PCT No.: PCT/AU2020/051393

§ 371 Date: Jun. 17, 2022

(30) Foreign Application Priority Data
Dec. 18, 2019 (AU) 2019904801

(51) Int. Cl. F28D 20/00; F24S 60/20; B01J 20/04; B01J 20/30; C09K 5/16; B01D 53/02; B01J 20/34

(52) U.S. Cl. CPC F28D 20/003; F24S 60/20; B01J 20/043; B01J 20/3078; C09K 5/16; B01D 53/02; B01J 20/34; B01J 20/041

(57) ABSTRACT

A method of storing energy is disclosed. The method comprises heating a material that comprises a CO₂ sorbed product and an additive to desorb CO₂ from the material and to convert the CO₂ sorbed product to a CO₂ sorbent. The additive is selected such that it at least partially prevents during heating (i) sintering of the CO₂ sorbent and/or the CO₂ sorbed product; and (ii) the formation of a crust on the material, the crust minimising or preventing the CO₂ sorbent and CO2 from reacting with one another to form the CO₂ sorbed product in a subsequent CO₂ absorption step. Also disclosed is a composition used to sorb and desorb CO₂ in a thermal battery, and a system for implementing the method, the system using the composition.

### TECHNICAL FIELD

This disclosure relates generally to thermal batteries that use a CO₂ sorbent such as CaO/CaCO₃.

### BACKGROUND

Concentrated solar thermal power (CSP) plants are becoming a widespread renewable energy source supplementing photovoltaics and wind power. First generation CSP plants store thermal energy using the specific heat of molten salt, i.e. a 0.4NaNO₃-0.6KNO₃ mixture, with an operating temperature between 290° C. and 565° C. The low operating temperature and low energy density (413 kJ/kg) of the molten salt technology results in a high energy storage cost. Thus, higher operating temperatures, efficiencies, and lower costs are desired. A wide variety of materials have been suggested as the successor to molten salt. Emerging thermochemical energy storage technologies show promise, including gas-solid systems such as metal hydrides and metal carbonates, which have high energy densities (651-8397 kJ/kg) making them attractive as thermochemical energy storage (TOES) materials. The quantity of calcium carbonate required to store 1 TJ of energy is only 4% the cost of molten salts on a materials basis.

One of the major problems of using CaCO₃ as a TOES material is that CaCO₃ degrades with increasing number of CO₂ release and absorption cycles. For example, the CO₂ capacity in CaCO₃ drops to only ˜8% of its initial capacity after 500 cycles. The cause of the capacity loss may be assigned to a range of events, including a loss of porosity in the formed CaO, sintering of the CaCO₃ due to the temperatures required for CO₂ cycling (e.g. >800° C.), and the limited CO₂ diffusion through CaCO₃.

Various attempts have been made to improve the cyclic stability of CaCO₃-based TOES materials. A steam reactivation process can be used to replenish the cyclic capacity in CaCO₃ through the formation of Ca(OH)₂, which can favourably alter the particle morphology. However, the effect of forming Ca(OH)₂ is strongly dependent on temperature, steam content, and must be performed every cycle to maintain decent cyclic capacity. Further, steam reactivation must be performed at relatively low temperatures, usually below 560° C., due to the thermodynamics for Ca(OH)₂ formation, which often involves a further step to decrease the reactor temperature for steam reactivation. Due to these constraints, it is not feasible to operate a CSP thermochemical storage system that requires steam reactivation.

It is to be understood that, if any prior art publication is referred to herein, such reference does not constitute an admission that the publication forms a part of the common general knowledge in the art, in Australia or any other country.

### SUMMARY

The disclosure provides a method of storing energy. The method comprises heating a material comprising a CO₂ sorbed product and an additive to desorb CO₂ from the material and convert the CO₂ sorbed product to a CO₂ sorbent. The additive is selected to at least partially prevent during heating: sintering of the CO₂ sorbent and/or the CO₂ sorbed product; and the formation of a crust on the material. The crust can minimise or prevent the CO₂ sorbent and CO₂ from reacting with one another to form the CO₂ sorbed product in a subsequent CO₂ absorption step.

The disclosure provides a method of storing energy. The method comprises applying heat to material comprising CaCO₃ and an additive to desorb CO₂ from the material to form CaO, the CaO being able to react with CO₂ in a further step to reform CaCO₃. The additive is selected to at least partially prevents sintering of CaO/CaCO₃ and the formation of a crust that prevents CaO and CO₂ from reacting with one another to form CaCO₃

The disclosure provides a method of storing energy. The method comprises applying heat to sorb or desorb CO₂ from material comprising CaO and/or CaCO₃ and an additive. The additive is selected to at least partially prevent sintering of CaO/CaCO₃ and the formation of a crust that prevents CaO and CO₂ from reacting with one another to form CaCO₃.

The disclosure provides a method of storing energy. The method comprises desorbing CO₂ from material comprising CaCO₃ and/or CaO and an additive comprising Zr- or Al-based species, wherein the step of desorbing CO₂ includes heating the material between 600° C. and 1200° C. to convert CaCO₃ to Ca0. The additive is selected to at least partially prevent during heating: (i) sintering of CaO/CaCO₃; and (ii) the formation of a crust on the material. The crust minimise or prevent CaO and CO₂ from reacting with one another to form CaCO₃ in a subsequent CO₂ absorption step.

The disclosure provides a composition used to sorb and desorb CO₂ in a thermal battery. The composition comprises a form of calcium that is capable of absorbing or desorbing CO₂ to, respectively, form a CO₂ sorbed product or CO₂ desorbed product; an additive having a concentration ranging from about 5 wt. % to about 95 wt. % relative to an amount of the CO₂ sorbed product; wherein the additive at least partially prevents during heating of the composition sintering of the CO₂ sorbed/desorbed product and the formation of a crust that minimises or prevents the CO₂ desorbed product and CO₂ from reacting with one another to form the CO₂ sorbed product.

The disclosure also provides a system for storing energy, comprising: a reactor comprising a material that is capable of absorbing or desorbing CO₂ to, respectively, form a CO₂ sorbed product or CO₂ desorbed product, the material having an additive that at least partially prevents during heating: sintering of the CO₂ sorbent/sorbed product; and the formation of a crust on the material, the crust minimising or preventing the CO₂ sorbent and CO₂ from reacting with one another to form the CO₂ sorbed product; and a CO₂ source that is in fluid communication with the reactor to allow a flow of CO₂ between the reactor and CO₂ source during absorption or desorption of CO₂.

### BRIEF DESCRIPTION OF THE FIGURES

Embodiments of the disclosure will now be described, by way of example only, with reference to the following non-limiting Figures.

FIG. 1 shows a schematic representation of an embodiment of a system of the disclosure;

FIG. 2 shows CO₂ absorption data of various CaCO₃-additive samples over 50 calcination-carbonation cycles at 900° C. for 30 min carbonation and 20 min calcination.

FIG. 3 shows CO₂ absorption data comparing the influence of ZrO₂ content and ball-milling parameters at 900° C. for 30 min carbonation and 20 min calcination.

FIG. 4 shows CO₂ absorption data comparing the influence of Al₂O₃ content and extended calcination/carbonation time for up to 50 calcination-carbonation cycles at 900° C. All samples were cycled for 30 min carbonation and 20 min calcination, except the “Ext.” sample that was cycled for 60 min carbonation and 60 min calcination.

FIG. 5 shows CO₂ absorption data of CaCO₃—Al₂O₃ (20 wt. % bulk) over 500 calcination-carbonation cycles at 900° C. with varying calcination/carbonation times.

FIG. 6 shows an expansion of FIG. 5 from cycle #350 to cycle #500.

FIG. 7 shows powder X-ray diffraction (PXD) data of CaCO₃—ZrO₂ (20 wt. %) of the as-milled sample (bottom) and CO₂ absorbed samples (top) after 50 calcination/carbonation cycles showing the formation of ternary compounds after cycling. Wavelength=1.54056 Å.

FIG. 8 shows PXD data of CaCO₃—Al₂O₃ (20 wt. %) of the as-milled sample (bottom) and CO₂ absorbed samples (top) after 50 calcination/carbonation cycles showing the formation of ternary compounds after cycling. Wavelength=1.54056 ∈.

FIG. 9 shows PXD data of CaCO₃—Al₂O₃ (20 wt. %) absorbed after 500 calcination/carbonation cycles. Wavelength=1.54056 Å.

FIG. 10 shows in situ PXD data of CaCO₃—Al₂O₃ (20 wt. %, bulk) at 917° C. The CO₂ pressure profile is indicated to the right. Carbonation performed for ˜20 min and calcination for ˜30 min in a total of 5 cycles. The bottom of the figure signifies the start of the cycles. Symbols denote: triangle is CaCO₃; diamond is Ca0; circle is Al₂O₃; square is Ca—Al—O derived compounds. Wavelength=0.590458 Å.

FIG. 11 shows in situ PXD data of CaCO₃—ZrO₂ (40 wt. %, bulk) at 917° C. The CO₂ pressure profile is indicated to the right. Carbonation performed for ˜20 min and calcination for ˜30 min in a total of 5 cycles. The bottom of the figure signifies the start of the cycles. Symbols denote: triangle is CaCO₃; diamond is CaO; circle with addition sign is ZrO₂; pentagon is CaZrO₃. Wavelength=0.590458 Å.

FIG. 12 shows scanning electron microscopy data comparing the morphologies of the as-milled (left column) and cycled samples (right column), and energy dispersive spectroscopy showing the elemental distribution of aluminium and zirconium in the respective samples (Al: purple; Zr: yellow). a-b: CaCO₃; c-f: CaCO₃—Al₂O₃; g-k: CaCO₃—ZrO₂.

FIG. 13 shows an experimental setup based on CO₂-storage in either A) activated carbon with pressure generated by the thermal profile of the activated carbon (Scenarios 1&2) or B) a carbon dioxide compressor (Scenario 3), from Example Scale-up of a CaCO₃—Al₂O₃ (16.7 wt %) System.

FIGS. 14a & 14b show Pressure-Composition-Isotherms of the activated carbon in the pressure range utilized in Example Scale-up of a CaCO₃—Al₂O₃ (16.7 wt %) System.

FIG. 15 shows comparison of the different scenarios investigated in Example Scale-up of a CaCO₃—Al₂O₃ (16.7 wt %) System.

FIG. 16 is a ‘zoom-in’ depiction showing the rapid temperature spikes observed upon carbonation in Scenario 3 (Example Scale-up of a CaCO₃—Al₂O₃ (16.7 wt %) System).

FIG. 17 shows a Scanning Electron Microscope (SEM) micrograph of CaCO₃—Al₂O₃ sample after thermochemical cycling near 900° C., from Example Scale-up of a CaCO₃—Al₂O₃ (16.7 wt %) System.

FIG. 18 shows a thermogravimetric analysis and differential scanning calorimetry (TGA-DSC) of CaCO₃—ZrO₂(13.3 wt %)-Al₂O₃(13.3 wt %) from room temperature to 1000° C. (ΔT/Δt=10° C. min⁻¹) under argon flow (20 mL min⁻¹), from Example adding Mixtures of Oxides to Limestone (CaCO₃).

FIG. 19 shows isothermal calcination/carbonation data of a CaCO₃—ZrO₂(13.3 wt %)-Al₂O₃(13.3 wt %) sample over 50 CO₂ cycles at T˜900° C. and p_{carbonation}˜5 bar and p_{calcination}<0.8 bar for 20 and 30 minutes, respectively, from Example adding Mixtures of Oxides to Limestone (CaCO₃).

FIG. 20 shows a comparison of reaction kinetics between pristine CaCO₃ (green), CaCO₃—ZrO₂ (20 wt %, red), CaCO₃—Al₂O₃ (20 wt %, blue) and the combined CaCO₃—ZrO₂(13.3 wt %)-Al₂O₃(13.3 wt %, grey), from Example adding Mixtures of Oxides to Limestone (CaCO₃).

FIG. 21 shows powder X-ray diffraction data of CaCO₃—ZrO₂—Al₂O₃ samples after 50 CO₂ cycles in the desorbed state, from Example adding Mixtures of Oxides to Limestone (CaCO₃).

FIG. 22 shows in situ SR XRD data (λ=0.82502 Å) of CaCO₃—ZrO₂—Al₂O₃ at T=917° C., from Example adding Mixtures of Oxides to Limestone (CaCO₃).

FIG. 23 shows Scanning electron microscopy (SEM) pictures and energy-dispersive X-ray spectroscopy (EDS) mapping of as-prepared CaCO₃—Al₂O₃—ZrO₂ and after 50 CO₂ capacity cycles, from Example adding Mixtures of Oxides to Limestone (CaCO₃).

FIG. 24 shows SAXS data showing the Porod region (power law slope=−4) from where the specific surface area (SSA) is determined, from Example adding Mixtures of Oxides to Limestone (CaCO₃).

### DETAILED DESCRIPTION OF SPECIFIC EMBODIMENTS

An embodiment of the disclosure provides a method of storing energy. The method comprises desorbing CO₂ from a material comprising a CO₂ sorbed product and/or a CO₂ sorbent and an additive. The step of desorbing CO₂ includes heating the material to convert the CO₂ sorbed product to the CO₂ sorbent. The additive is selected to minimise during heating: sintering of the CO₂ sorbent/sorbed product; and the formation of a crust on the material. Such a crust can minimise or prevent the CO₂ sorbent and CO₂ from reacting with one another to form the CO₂ sorbed product in a subsequent CO₂ absorption step.

The CO₂ sorbent is a species that is capable of absorbing CO₂. The CO₂ sorbent may be calcium-based. In one embodiment, the CO₂ sorbent is CaO and the CO₂ sorbed product is CaCO_{3.} The sorbent may be MgO, BaO and/or SrO, and the sorbed product may be the respective carbonate form e.g. MgCO₃, BaCO₃ and/or SrCO₃. The CO₂ sorbent may comprise a mixture of species capable of sorbing/desorbing CO₂. For example, the CO₂ sorbent/sorbed product may include species such as dolomite (CaMg(CO₃)₂). The material may initially be provided as CaO that is reacted with CO₂ to form CaCO₃ in a step prior to desorbing CO₂. The formed CaCO₃ may then be desorbed using the disclosed method. Alternatively, CaCO₃ may be initially provided and then subject to heating to desorb CO₂. An advantage of initially providing CaCO₃ is that it should not react with any CO₂ or H₂O present in the environment, for example, during assembly of a thermal battery, making it simpler to calculate the required amount of additive needed. The additive may be added to CaO and/or CaCO₃. The CO₂ sorbed product and CO₂ sorbent may form different phases. The material may be formed from particles that aggregate together. Aggregation may change a morphology of the material. The particles may be particles of the CO₂ sorbed product and CO₂ sorbent.

Throughout this disclosure, the term “sorbing” and “absorption” are used interchangeably, and the terms “desorbing” and “desorption” are used interchangeably.

The crust may reduce the permeability of, or be impervious to, CO₂ diffusion at a surface of the material (e.g. particle) to an interior of the material. For example, for a CaO particle, absorption of CO₂ at the surface forms a CaCO₃ crust. If the particle is large enough, such as through growth due to sintering processes, the presence of the crust provides a layered structure having a CaO core and a CaCO₃ crust encapsulating the core. The core-shell or layered structure will generally have a lower CO₂ absorption capacity compared to a non-core-shell structure as the CaCO₃ crust prevents diffusion of CO₂ into the CaO core. Likewise, the CaCO₃ crust may prevent the migration of CaO from the core to a surface of the particle to allow CaO to react with CO₂ at the surface. Put simply, the crust may prevent CaO and CO₂ from reacting with one another.

The additive may help to separate the CO₂ sorbed product phase and CO₂ sorbent phases. This separation may help to prevent the CO₂ sorbed product phase and CO₂ sorbent phases from combining and growing in size e.g. by sintering.

The additive may prevent the formation of the crust. However, in some embodiments, the additive prevents the formation of a contiguous crust. Put another way, the additive may form a discontinuous crust that is formed from two different species. For example, for CaO/CaCO₃, the additive may allow the formation of isolated regions of CaCO₃ that are disbursed around the particle. The areas between the disbursed CaCO₃ regions may allow CO₂ to permeate into the particle and/or allow CaO from a core of the material/particle to migrate to a surface of the material/particle to react with any CO₂ present at the surface. The additive may form the areas between the CaCO₃ regions. In an embodiment, during the CO₂ absorption step, the additive allows the CO₂ sorbent to migrate through the material from an inner region to a surface to react with CO₂ present at the surface of the material to form the CO₂ sorbed product. For example, the additive may facilitate Ca²⁺ and/or O²⁻ mobility through the material.

The heating step may be performed at a temperature greater than about 600° C., such as about 800° C. The heating step may be performed at a temperature less than about 1200° C. In an embodiment, the heating step is performed at a temperature ranging from about 800° C. to about 1000° C. In an embodiment, the heating step is performed at a temperature of about 900° C. At these temperatures, species such as CaO tend to sinter. For systems and methods that rely on CaO/CaCO₃ to absorb or desorb CO₂, sintering can significantly limit the use of CaO/CaCO₃ to absorb or desorb CO₂. A problem with sintering is that it increases a size of the material/particles. For particles of CO₂ sorbent, increasing the size of the particles beyond a threshold amount generally results in a reduction of the CO₂ absorption capacity of the CO₂ sorbent. Therefore, reducing or eliminating sintering may help to prevent or slow down a decrease in the CO₂ absorption capacity of the CO₂ sorbent during use of the CO₂ sorbent for storing energy.

The temperature that the heating step is performed at may be selected to minimise or eliminate the formation of species that impede the ability of the particle to sorb or desorb CO₂. For example, the additive may react with CaO and/or CaCO₃ to form species that impede the ability of the additive to prevent sintering and the formation of the crust. The temperature may be selected to promote favourable Carnot efficiencies whilst minimising the formation of undesirable by-products, such as sintered particles. Heat transfer during sorbing and desorbing CO₂ may be performed under isothermal conditions.

The additive may be a metal oxide having at least one metal. The additive may be a ternary compound. The additive may be provided as an additive precursor. The additive precursor may react with the CO₂ sorbent and/or CO₂ sorbed product to form the additive in situ during heating to convert the CO₂ sorbed product to the CO₂ sorbent. When an additive precursor is used, the heating conditions and the number of times sorption and desorption steps are performed may determine the type of additive formed. In an embodiment, the additive precursor includes Al₂O₃ and/or ZrO₂. When Al₂O₃ is used as the additive precursor, the Al₂O₃ may react with CaCO₃ to form a calcium aluminate species as the additive. When ZrO₂ is used as the additive precursor, the ZrO₂ may react with CaCO₃ to form a CaZrO₃ additive. The additive precursor may comprise Al₂O₃ and ZrO₂ together.

The additive and/or additive precursor may comprise one or more species. For example, the additive may include CaAl₂O₄, Ca₃Al₂O₆, Ca₅Al₆O₁₄, Ca₉Al₆O₁₈, Ca₁₂Al₁₄O₃₃ or a combination thereof. The additive may include a mixture of CaZrO₃ and a calcium aluminate species. In an embodiment, the additive comprises Ca₅Al₆O₁₄. The Ca₅Al₆O₁₄ may react to form Ca₉Al₆O₁₈. A mixture of Ca₅Al₆O₁₄ and/or Ca₉Al₆O₁₈ may form a major additive fraction and CaAl₂O₄ and/or Ca₃Al₂O₆ may form a minor additive fraction. The major fraction may comprise >95 wt. % of the additive. The types of species formed may be determined by the thermodynamics of the reagents at the temperature used for sorption/desorption. For example, the major fraction may comprise >95% CaZrO₃ and/or calcium aluminate. The ratio of [Ca₅Al₆O₁₄]:[Ca₉Al₆O₁₈] may range from about [100]:[0] to about [0]:[100]. The ratio of [Ca₅Al₆O₁₄]:[Ca₉A₁₆O₁₈] may start at about [100]:[0] and change to about [0]:[100] over a number of cycles of CO₂ sorption and desorption. For example, when Al₂O₃ is used as the additive precursor, the Al₂O₃ may first react with CaCO₃/CaO to form Ca₅Al₆O₁₄, and the Ca₅Al₆O₁₄ may then partially convert to Ca₉Al₆O₁₈ to provide a ratio of [Ca₅Al₆O₁₄]:[Ca₉Al₆O₁₈] over a number of cycles. In an embodiment, a combination of Ca₅Al₆O₁₄ and Ca₉Al₆O₁₈ may comprise >95% of the additive. In an embodiment, a ratio of [Ca₅Al₆O₁₄]:[Ca₉Al₆O₁₈] is about [50]:[50]. The ratio of [Ca₅Al₆O₁₄]:[Ca₉Al₆O₁₈] may reach about [50]:[50] after 500 cycles.

The additive may act as an “oxygen conductor” that allows oxygen-species such as oxygen ions to migrate from a surface of the material towards or away from an interior of the material. In addition to or in place of the additive may act as an “calcium conductor” that allows calcium-species such as calcium ions to migrate from a surface of the material towards or away from an interior of the material. Reference to calcium in the “calcium conductor” does not limit the ability of the additive to allow only migration of calcium ion, and the additive may allow migration of ions of other metal species such as Mg, Ba and/or Sr. Put another way, the additive may act as an “ion conductor” that allows metal ions to migrate from a surface of the material towards or away from an interior of the material. The additive may also act as “CO₂ sorbent carrier” that allows the CO₂ sorbent, such as CaO, to migrate from an interior of the material towards a surface of the material to allow the CO₂ sorbent to react with CO₂ present at the surface of the material. For example, without being bound by theory, it is thought that when the CO₂ sorbent is CaO and the additive includes Ca₆Al₆O₁₄, Ca²⁺ in the Ca₆Al₆O₁₄ may dissociate to allow a calcium species to react with CO₂ to form CaCO₃. At the same time, CaO located elsewhere, such as towards an interior of the material, may react with the additive to reform Ca₅Al₆O₁₄. In this way, the additive may react as a “calcium conductor” that allows conduction of calcium through the material. Another possible mechanism may be that, when Ca₉Al₆O₁₈ acts as the additive, the crystal structure of the additive is built from Al₆O₁₈ ‘rings’ with Ca²⁺ inside the rings. However, only 72 of possible 80 positions are occupied by Ca²⁺ leaving room for Ca²⁺to ‘jump’ between the positions to allow migration of Ca²⁺ though the additive and material. Put simply, the additive may not react as such, but may act as a conduit for Ca²⁺ ions, feeding them from one location to another as needed.

This example is made with reference to calcium and an additive containing aluminium, but the disclosure is not limited to the use of calcium and an additive containing aluminium and other species such as CaZrO₃ could act as the “oxygen conductor” and “CO₂ sorbent carrier”.

The method may further comprise a step of sorbing CO₂ onto the CO₂ sorbent to reform the CO₂ sorbed product. The step of reforming the CO₂ sorbed product releases energy. The released energy can be captured and used to power any system that is capable of generating electricity, such as a turbine generator, heat engine, etc. The heat can also be provided to an industrial process (e.g. directly). The step of sorbing and desorbing CO₂ onto/from the material may be carried out under isothermal conditions.

The effect of the additive depends on the type of additive and its concentration. In an embodiment, a concentration of the additive ranges from about 5 wt. % to about 95 wt. % relative to the amount of CO₂ sorbed product (e.g. CaCO₃). In some embodiments a concentration of the additive ranges from, about 10 wt. % to about 70 wt. %, about 10 wt. % to about 50 wt. %, or about 20 wt. % to about 40 wt. %. When the additive reacts with the CO₂ sorbed product and/or CO₂ sorbent, such as when an additive precursor is used to form the additive, the CO₂ absorption capacity of the material decreases due to the reduced amount of CO₂ sorbent. When the additive reacts with the CO₂ sorbed product and/or CO₂ sorbent, this decrease in the amount of CO₂ sorbent should be taken into consideration when determining the CO₂ absorption capacity.

A cycle of desorbing CO₂ from the material and absorbing CO₂ onto the material may be repeated at least 500 times. The time used for CO₂ absorption and CO₂ desorption may be the same. The time for CO₂ absorption and CO₂ desorption may differ. The time used for CO₂ absorption and CO₂ desorption may change with an increasing number of cycles. For example, a time of 1 hour may initially be used for CO₂ absorption and CO₂ desorption, then after a certain number of cycles a time greater than 1 hour may be used for CO₂ absorption and CO₂ desorption. The CO₂ absorption capacity of the material may be changed by changing the CO₂ absorption time. For example, after a number of cycles using a constant CO₂ absorption and CO₂ desorption time, the CO₂ absorption capacity of the material may drop, but absorbing CO₂ for an extended period of time may increase the CO₂ absorption capacity of the material. Providing a step of extended CO₂ absorption may be used to “regenerate” the material to increase the CO₂ absorption capacity. Therefore, an embodiment of the method includes regenerating the material by subjecting the material to an extended CO₂ absorption step. Desorption of CO₂ may be performed under reduced pressure compared to the pressure used to absorb CO_{2.} A pressure used for CO₂ absorption and CO₂ desorption may be up to about 5.0 bar. For example, desorption may be performed under vacuum. Pressures above 5.0 bar may be used, for example, up to about 60 bar. However, for such higher pressures, the use of pressure vessels and the like can be required. This can increase the costs of building and maintaining a system used to perform the disclosed method.

The pressure used for CO₂ storage can be up to about 100 bar. The CO₂ may be stored in the form of a gas, liquid or in a supercritical state. The CO₂ may also be stored in the form of another metal carbonate.

To form the material, CaCO₃ and/or CaO may first be milled before use in the disclosed method. Milling helps to increase a surface area of the material and to disburse e.g. the additive or additive precursor. In an embodiment the material is milled to a size less than 10 μm. The as-milled materials may have the CO₂ sorbed product and additive precursor distributed as discrete regions/particles. However, upon heating, the CO₂ sorbed product/CO₂ sorbent and the formed additive may become evenly distributed. Upon heating, a morphology of the material may change from particulate matter to a porous structure. It should be noted that milling is not required in all embodiments.

The CO₂ may be provided as a gas. The CO₂ may be provided as a supercritical fluid. The temperatures and pressures used by the disclosed method prevents the use of liquid CO₂. The CO₂ may be entrained in a carrier gas and the CO₂ sorbent absorbs the CO₂ entrained in the carrier gas. The carrier gas may act as a heat transfer fluid. When a carrier gas is used to deliver entrained CO₂, the CO₂ may have a concentration of about 400 ppm. In an embodiment the CO₂ has a purity >95%, such as >99%. In an embodiment, the CO₂ is pure i.e. has a purity 99.95%. The method may be performed in the absence of water. Whilst the presence of water may form hydroxyl/hydroxide species, such as Ca(OH)₂, at the high temperatures of operation, the formation of hydroxyl/hydroxide species is unlikely. Hence, at such high temperatures, having some moisture in the gas stream will not be an issue, as it will not be reactive at such temperatures, and it may even facilitate good heat transfer. Thus, typically the CO₂ sorbent and CO₂ sorbed product will be free from hydroxyl/hydroxide species.

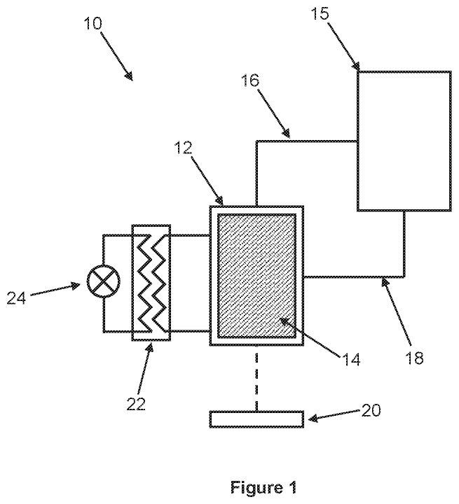

A system used for storing energy is shown in FIG. 1. The system is in the form of a thermal battery system 10. System 10 has a reactor 12 that houses material 14 that can store thermal energy. In one form, the material 14 that can store thermal energy is the disclosed material/particles. In an embodiment, the material 14 is a form of calcium that is capable of absorbing CO₂ or desorbing CO₂ to form a CO₂ sorbed product or CO₂ desorbed product. A CO₂ source 15 is in fluid communication with the reactor via conduits 16 and 18. Conduits 16 and 18 act as an input/output line to the CO₂ source 15. However, in an embodiment only one conduit acts as the input/output line to the CO₂ source. A heating system 20 is in thermal communication with the reactor 12. The heating system 20 can take many forms. In one form, the heating system uses renewable power, such as photovoltaic- or wind-based power, to heat the reactor 12, but in particular the material. The heating system may include a dish used to concentrate thermal energy from the sun, such as that utilised for a solar-powered Stirling engine. Other forms of heating systems are included within the scope of the current disclosure. Depending on the type of heating system used, a heat exchanger (not shown) may be used in conjunction with a heat transfer fluid to heat the material 14. The heat transfer fluid may be a gas fed into the powder bed itself, or be the CO₂ working gas.

In use of the system 10, the material 14 is heated to desorb CO₂. The material 14 may be heated to about 800° C. to about 1000° C. by the heating system 20. The desorbed CO₂ is then transferred from the reactor 12 to the CO₂ source 15 via the conduits 16 or 18. It should be appreciated that one of the conduits 16 or 18 acts as an inlet into the CO₂ source 14 and the other of the conduits 16 or 18 acts as an outlet from the CO₂ source 14. Conduits 16 and/or 18 may be provided with control valves, one-way valves, expansion chambers and/or pumps to assist in removing any CO₂ desorbed in the reactor 12.

The CO₂ source 15 can take many forms. For example, the CO₂ source 15 could be a vessel capable of storing CO₂ either in gas, liquid or supercritical form. The CO₂ source 15 could include or be formed from materials capable of storing CO₂, such as one or more of: molecular sieves (zeolites), metal organic frameworks, nanomaterials, and activated carbon. Activated carbon has the advantage of being cost effective and readily available. An Example using activated carbon is described below.

An advantage of using materials to store CO₂ is that a pressure of the CO₂ in the system can be controlled by adjusting a temperature of the material capable of storing CO₂ instead of using compressors and pumps. The CO₂ source could be a carrier gas that has a component of CO₂. For example, air having about 400 ppm to about 600 ppm CO₂ could be used as the CO₂ source 15. When materials capable of storing CO₂ are used as the CO₂ source 15, the system 10 may have expansion valves located on conduits 16 and/or 18 and heat exchangers in communication with the expansion valves and/or heating system 20 to control the temperature of the CO₂ source 15. In the embodiment shown in FIG. 1, the system 10 has a system for generating electricity 24. In one embodiment, the system for generating electricity has a steam turbine generator 24 that utilises heat generated by the reactor 12 during absorption of CO₂. In some forms, instead of a steam turbine generator, the system for generating electricity can employ a heat engine. A heat exchanger 22 is used to transfer heat generated by the reactor 12 to the system for generating electricity 24.

In use of the system 10, the material is heated so that CO₂ is desorbed from a CO₂ sorbed product such as CaCO₃ to form a CO₂ desorbed product such as CaO. The desorbed CO₂ is transferred to the CO₂ source 15. The step of desorbing CO₂ stores chemical energy in the material 14 in the reactor as the CO₂ desorbed product. When the energy stored in the reactor 12 is required, CO₂ from the CO₂ source 15 is transferred to the reactor 12 where the CO₂ desorbed product can react with CO₂ to reform the CO₂ sorbed product thereby converting chemical energy to thermal energy. The process of absorption and desorption may be performed isothermally. The process of absorption and desorption may be performed at conditions close to isothermal conditions. For example, the temperature may fluctuate by about 5% on either side of the isothermal temperature. The thermal energy released upon formation of the CO₂ sorbed product is captured by the heat exchanger 22 and is transferred to the system for generating electricity 24. This process of desorption and absorption forms a cycle that is repeated as many times as energy storage and discharge is required.

The system 10 has been described as generating heat for electricity generation, but the system 10 is not limited to generating heat for electricity generation. For example, heat generated by the system 10 could be used for other applications, such as a heat source for example in industrial processes.

### EXAMPLES

Embodiments of the disclosure will now be explained with reference to the following non-limiting Examples.

### Example—Additive Enhanced Thermochemical Energy Storage Properties of Limestone

Methods

Sample Preparation

Different compositions were formed by mixing 4 g of CaCO₃ with the additives listed in Table 1. 10 mL of ethanol was then added, and the mixtures were ball-milled in stainless steel vials for 2 hours (15×1 min×8 reps; 12×8 mm stainless steel balls). After ball-milling, the samples were dried in an oven at 105° C. for approximately 1 hour to obtain a dry powder. Note, that the above procedure was carried out in an argon-filled glovebox for the sample with the Ni additive, which was dried by applying dynamic vacuum.

TABLE 1
Overview of additives used for CaCO₃-based compositions.

| | Wt. % | Mol. % | Vol. % |
|---|---|---|---|
| Additive | additive | additive | additive |
| C (graphite; 98-99%) | 20 | 67.6 | 23.0 |
| Al₂O₃ | 10, 20, 40 | 9.8, 19.7, 39.6 | 7.1, 14.6, 31.4 |
| 13 nm, 99.8% | | | |
| SiO₂ | 20 | 29.4 | 20.3 |
| 10-20 nm, 99.5% | | | |
| Fe₂O₃ | 20 | 13.5 | 11.5 |
| <50 nm | | | |
| Ni | 20 | 29.9 | 7.1 |
| <100 nm, ≥99% | | | |
| ZnO | 20 | 23.5 | 10.8 |
| dispersion, 40 wt. % | | | |
| in EtOH, <130 nm | | | |
| ZrO₂ | 20, 40 | 16.9, 35.1 | 10.7, 24.1 |
| <100 nm | | | |
| Zeolite Y, Na | 20 | 13.4 | 16.9 |
| 5.1:1 SiO₂:Al₂O₃ molar ratio | | | |
| Zeolite Y, H | 20 | 13.4 | 16.9 |
| 80:1 SiO₂:Al₂O₃ molar ratio | | | |
| Zeolite Mordenite, Na | 20 | 13.4 | 16.9 |
| 13:1 SiO₂:Al₂O₃ molar ratio | | | |
| BaCO₃ | 9.5 | 5 | 6.1 |

Sieverts' Method/Pressure-Composition-Isotherm

Samples were introduced in a SiC sample cell, which was attached via Swagelok parts to a Hy-Energy PCTpro E&E. The sample was heated to ˜900° C. (ΔT/Δt=5° C. min⁻¹) at p(CO₂)=10⁻² bar, hence decomposing (desorbing) the sample. Subsequently, cycling of the sample was initiated at isothermal conditions (˜900° C.) with an absorption at p(CO₂)˜5 bar for 30 mins in a 46.3 cm³ volume, followed by desorption at p(CO₂)˜10⁻² bar for 20 mins in a 206.7 cm³ volume. A total of 50 cycles was collected for all samples. Finally, the samples were absorbed and cooled under p(CO₂)˜5 bar. The cycling was extended to 500 cycles for the CaCO₃—Al₂O₃ (20 wt. %) sample using the same conditions as described above except calcination/carbonation times were varied.

Powder X-Ray Diffraction

X-ray diffraction (XRD) on powdered samples was performed on a Bruker D8 Advance diffractometer equipped with a CuK_{α1,12} source in flatplate geometry mode. Data were collected using a Lynxeye PSD detector from 15-70° 2θ at 0.02° steps.

In situ Synchrotron Radiation Powder X-Ray Diffraction

In situ time-resolved Synchrotron Radiation Powder X-ray Diffraction (SR-PXD) data were collected at the Powder Diffraction beamline at the Australian Synchrotron, Melbourne, Australia on a Mythen microstrip detector at λ=0.590458 Å. Powdered samples were loaded into quartz capillaries (i.d.=0.5 mm, o.d.=0.6 mm), which were attached to a gas system enabling control of CO₂ pressure. The samples were heated by a heat blower to 950° C. at ΔT/Δt=6° C. min⁻¹ while rotating during data acquisition. Temperature calibration was performed with NaCl and Ag.

Scanning Electron Microscopy

Scanning electron microscopy (SEM) and energy dispersive spectroscopy were performed using a Tescan Mira3 field emission SEM with an Oxford Instruments X-Max SDD X-ray detector and AZtec software. The SEM images were collected using a backscattered electrons detector, an accelerating voltage of 15 kV, an aperture size of 30 μm, and a working distance of ˜15 mm. SEM samples were prepared by embedding powdered samples in an epoxy resin and polished using colloidal silica, which were eventually sputter coated with a 10 nm thick carbon layer.

Results & Discussion

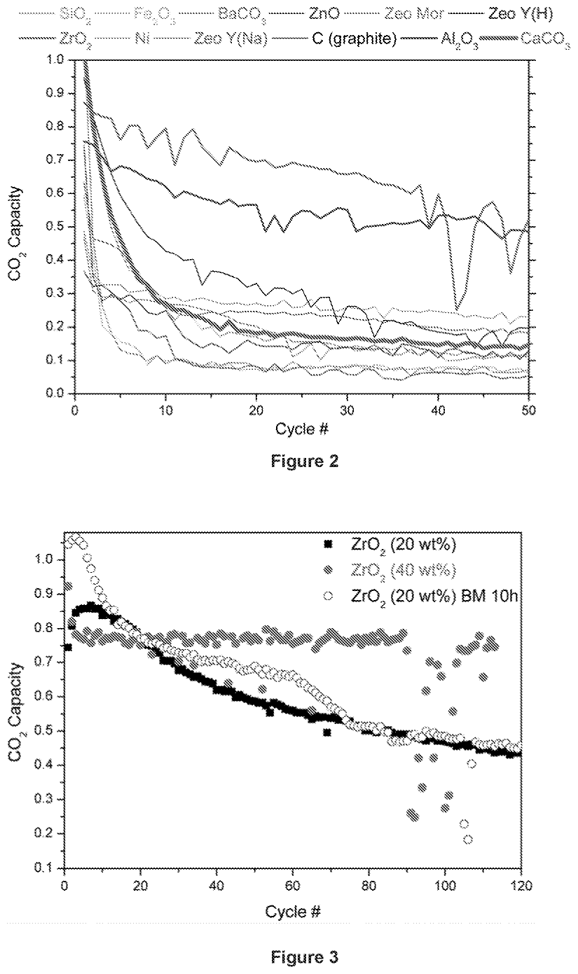

An overview of the samples prepared is given in Table 1. Generally, the CO₂ absorbing capacity of a CaO/CaCO₃ system decreases dramatically within the first 10 cycles (30 min carbonation, 20 min calcination). Eventually most of the samples have a CO₂ absorbing capacity of ˜14% after 50 calcination/carbonation cycles, which is less than when pure CaCO₃ is used as the starting (sorbed) material, which reaches a capacity of ˜17%, FIG. 2. However, a few samples showed promise to improve the cyclic stability of the CaCO₃. The SiO₂ and NaY sample react in a similar way with CaCO₃ to form spurrite (Ca₅(SiO₄)₂CO₃), and during cycling they both stabilise at ≈16-20% capacity, which is slightly better than for pure CaCO₃. Graphite addition aids in a slower capacity loss, though, after 50 cycles the CO₂ absorbing capacity is similar (˜20%) to samples when SiO₂ and NaY are used as the additive.

Addition of 20 wt. % ZrO₂ retains the capacity at ˜80% within the first 10 cycles, but a steady degradation of the sample is observed and at the end of 50 cycles the capacity is reduced to ˜55%. Similarly, the addition of 20 wt. % Al₂O₃ results in a steady capacity degradation and after 50 cycles it reaches ˜49%.

To further improve the CO₂ capacity, samples of varying weight ratios of ZrO₂ and Al₂O₃ were investigated. As evident from FIG. 3, addition of 40 wt. % ZrO₂ is superior to only 20 wt. %, as the addition of 20 wt. % ZrO₂ indicates a continuous capacity decrease but such capacity decrease is not observed with an addition of 40 wt. % ZrO₂. Additionally, extended ball-milling (10 hours) of the 20 wt. % ZrO₂ sample, which should result in smaller particles at the initiation of calcination/carbonation, eventually follows the same trend as for the same sample, but ball-milled for only 1 hour. Hence, an initially smaller particle size does not seem to play a role in determining CO₂ absorbing capacity when the sample is cycled multiple times.

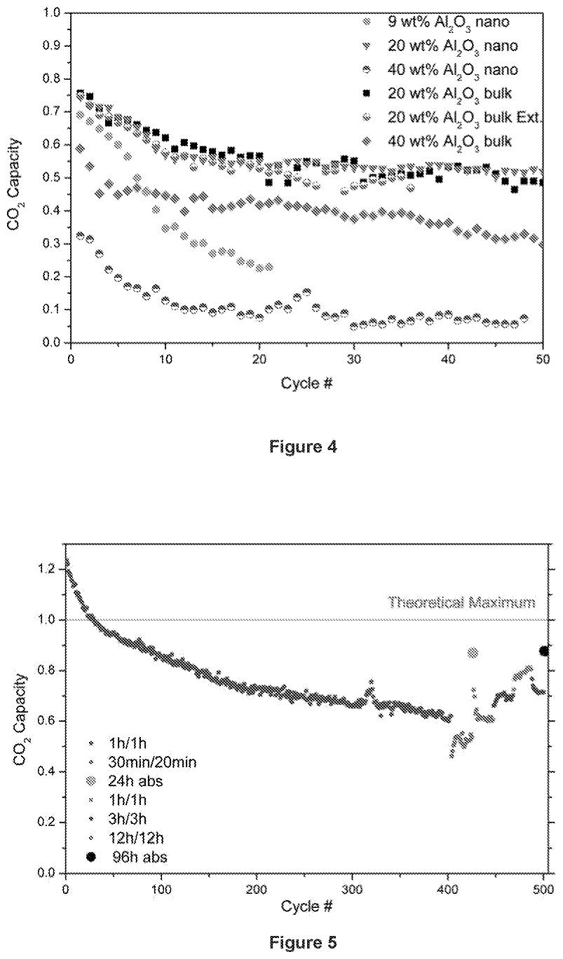

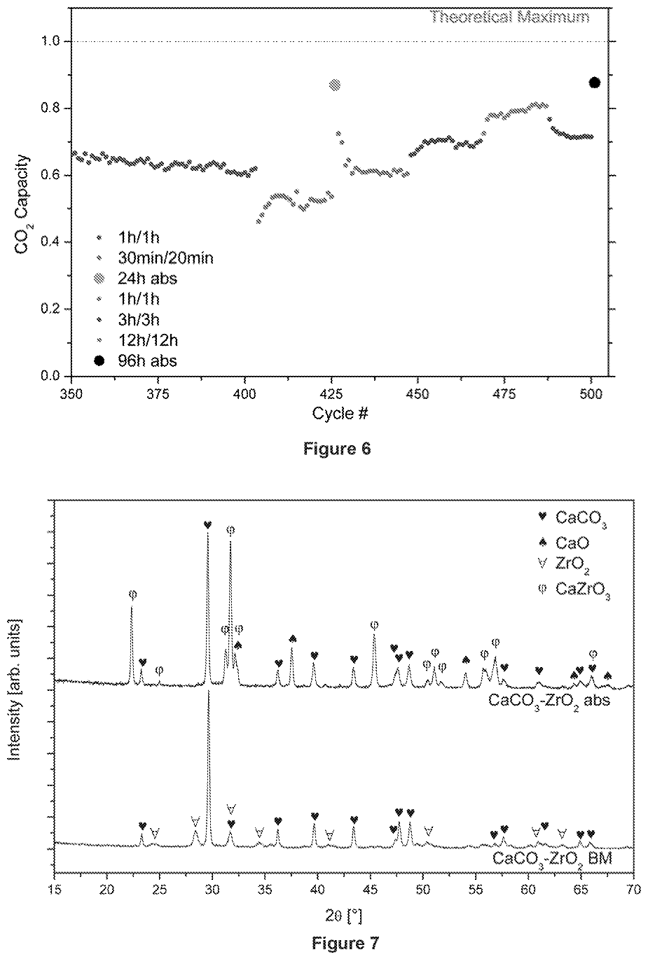

FIG. 4 compares different ratios of Al₂O₃ additive added to CaCO₃ and the influence of starting from bulk or nanoparticle Al₂O₃ (10-20 nm based on TEM, Sigma-Aldrich). The optimum ratio is found to be 20 wt. % of either bulk or nanoparticle Al₂O₃ with a CO₂ capacity of ˜49% after 50 cycles. Similar to samples having ZrO₂, the initial particle size of Al₂O₃ does not seem to have an influence on the CO₂ absorbing capacity. Eventually, the CaCO₃-20 wt. % Al₂O₃ sample was cycled 500 times under varying calcination/carbonation times, see FIG. 5 and FIG. 6. The capacity retention after 500 cycles is >80% when carbonation times are extended to >12 hours. Additionally, the response time is fast and capacity remains moderate as lowering the calcination/carbonation times to 30 and 20 min, respectively, still accounts for 50% capacity. Hence, the CaCO₃-20 wt. % Al₂O₃ system shows remarkable energy storage properties, i.e. response time and capacity, which make an embodiment of this system suitable for energy storage applications, such as a thermal battery.

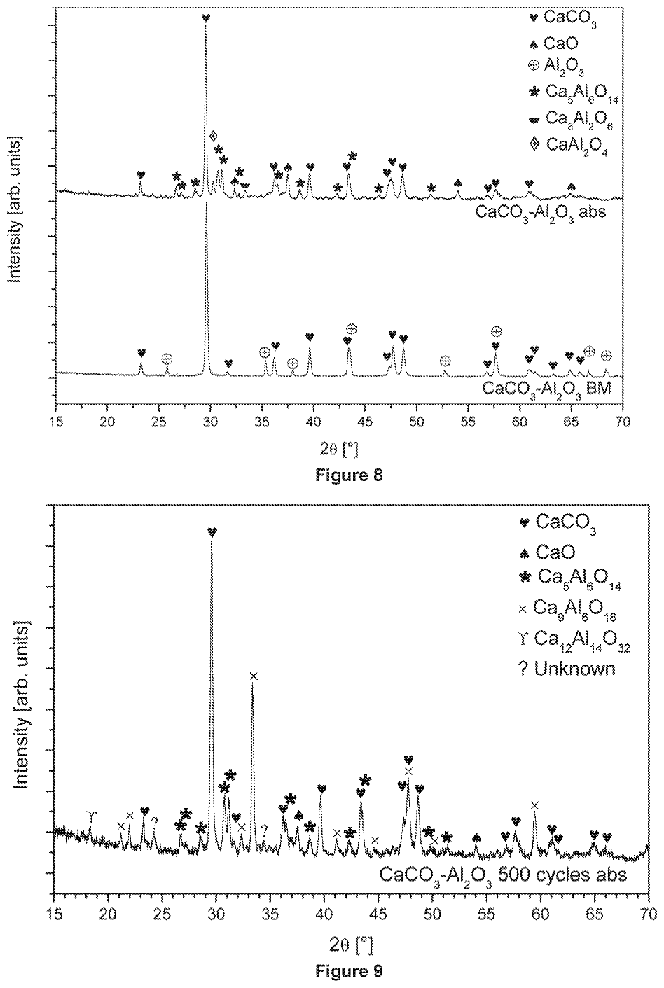

Comparison of powder X-ray diffraction (PXD) data of the as-milled samples and the carbonated samples after 50 calcination/carbonation cycles at 900° C. reveals that the additive reacts to form further additive products, which may partly explain the decreasing CO₂ absorption capacity of the samples. FIG. 7 shows the PXD data of the CaCO₃—ZrO₂ (20 wt. %) and FIG. 8 shows the PXD data of the CaCO₃—Al₂O₃ (20 wt. %), which highlights that a reaction between CaCO₃/CaO and the additive has occurred according to the following respective reaction schemes:

CaO(s)+ZrO₂(s)→CaZrO₃(s)

5CaO(s)+3Al₂O₃(s)→Ca₅Al₆O₁₄(s)

Minor quantities of side products, such as CaAl₂O₄ and Ca₃Al₂O₆ are also observed after 50 cycles for the samples that include Al₂O₃. These results show that in some embodiments the Al₂O₃ acts as an additive precursor that reacts with CaO during heating and during calcination/carbonation to form the additive.

Extending the cycling studies to 500 cycles (FIG. 9) for samples having Al₂O₃ reveals the conversion of minor fractions of CaAl₂O₄ and Ca₃Al₂O₆ into primarily Ca₆Al₆O₁₄ and Ca₉Al₆O₁₈ whilst a small fraction of Mayenite (Ca₁₂Al₁₄O₃₂, <3 wt. % from Rietveld refinement) is also observed.

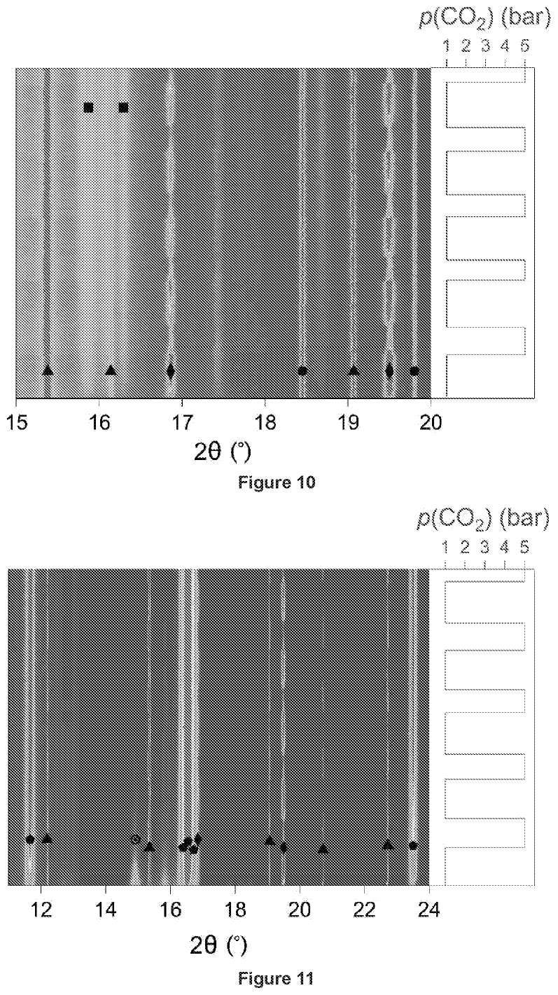

The ZrO₂ and Al₂O₃ enhanced CaCO₃ systems show cyclic capacities that are greatly enhanced compared to other tested additives (FIGS. 2-6). A simple additive that only restricts CaO/CaCO₃ sintering is not as effective to capacity retention. An important difference is the properties of the as-formed ternary oxides, CaZrO₃ and CaₓAl_{y}O_{z}. Some features that differentiate these ternary oxides from other additives include their ability to conduct ions at high temperatures and their ability to enable a higher CO₂ diffusion through the material. Closely related Ca₁₂Al₁₄O₃₃ (Mayenite) is reported to be an oxide ion conductor, and the layered structure of Ca₆Al₆O₁₄ is hypothesised to facilitate Ca²⁺ mobility. O²⁻ and Ca²⁺ migration through the additive structure can thus improve reaction kinetics and be beneficial in retaining the CO₂ capacity. The possibility of CaO migration is assigned to the low intrinsic defect formation energy of 1.61 eV to create a Ca-site Schottky type disorder in CaZrO₃. In FIG. 10, in situ XRD data of CaCO₃-Al₂O₃ shows the initial decomposition of CaCO₃ as Bragg reflections from CaO increases in intensity. As CO₂ gas is applied to the system, the CaO Bragg reflections decrease rapidly in intensity. Throughout the CO₂ absorption and desorption cycling, Ca—Al—O containing compounds continuously form, although in minor fractions. It is assumed that the forming products are the same as the ones observed in ex situ PXD data (FIGS. 8 and 9), but the few, low intensity, Bragg reflections makes identification unreliable.

FIG. 11 shows the in situ data of CaCO₃—ZrO₂ (40 wt. %, bulk). The immediate formation of CaZrO₃ and fast depletion of ZrO₂ (within ˜1 hour/1 cycle) is evident, and the amount of CaZrO₃ quickly reaches ˜65 wt. % of the sample (theoretically 67.1 wt. %). Furthermore, the crystallite size of CaCO₃ and CaO doubles and triples, respectively, over the 5 cycles applied here, which eventually may result in a capacity decrease due to presence of large crystallites. However, the evident formation and consumption of CaO shows the quick response of the system to calcinate/carbonate.

Table 2 shows the relative amounts, extracted from Rietveld refinements, of CaCO₃, CaO, CaZrO₃ and ZrO₂ during carbonation and calcination. The quantity of CaZrO₃ quickly increases then stabilises at about 77 wt. % whilst at the same time the amount of ZrO₂ decreases then stabilises at about 1 wt. %. The ratio of [CaCO₃]:[CaO] changes from about [27 wt. %]:[0.4 wt. %] to about [10 wt. %]:[13 wt. %] during carbonation and calcination.

TABLE 2
Parameters extracted from Rietveld
refinement, ZrO₂ (40 wt %) sample.

| | CaCOs [wt. %] | | | |
|---|---|---|---|---|
| Cycle# | (crystallite size, nm) | CaO | CaZrO₃ | ZrO₂ |
| 0 (carbonated) | 46 (115) | 3 (50) | 15 (6.7) | 36 |
| 1 (calcinated) | 14 (422) | 13 (161) | 65 (19.6) | 8 |
| 1 (carbonated) | 28.8 (245) | 0.4 | 65.8 (23) | 5 |
| 2 (calcinated) | 10 (565) | 13 (171) | 74 (24) | 3 |
| 2 (carbonated) | 26 (227) | 0.4 | 71 (26) | 2.6 |
| 3 (calcinated) | 9 | 12 (159) | 77 (27) | 2 |
| 3 (carbonated) | 25 (234) | 0.5 | 73 (28) | 1.5 |
| 4 (calcinated) | 9.5 | 12 (147) | 77 (29) | 1.5 |
| 4 (carbonated) | 25 (204) | 0 | 73.5 (26) | 1.5 |
| 5 (calcinated) | 9.4 | 12 (125) | 77.4 (27) | 1.2 |
| 5 (carbonated) | 25 (206) | 0.5 | 73.5 (27) | 1 |

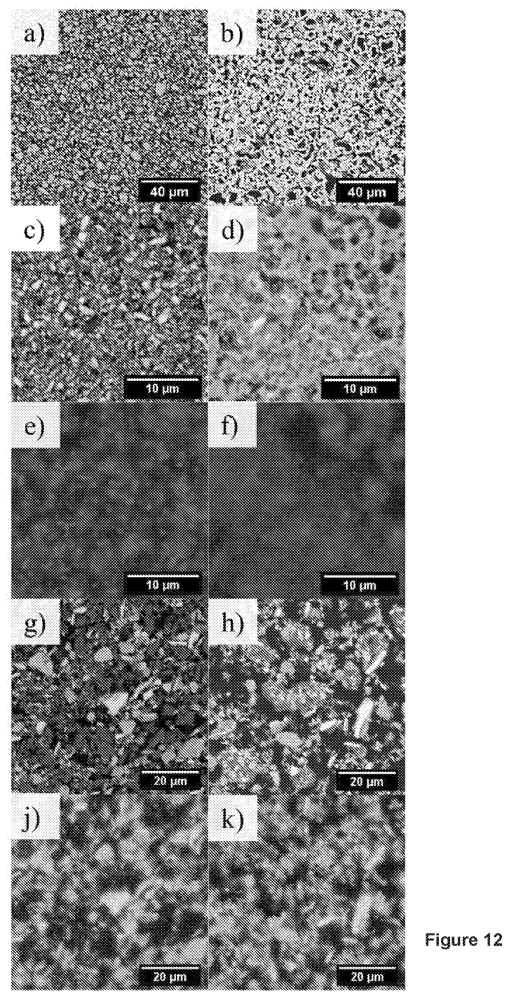

Scanning electron microscopy was used to analyse the particle morphology of as-milled and cycled samples, see FIG. 12. The as-milled CaCO₃ consists of finely divided particles in the size range 2-8 microns (FIG. 12a). The morphology significantly changes into a worm-like, porous structure after CO₂ absorption/desorption cycling (FIG. 12b). The porosity of the structure after cycling should promote permeation of CO₂ through the structure, but the interconnected particle morphology of CaCO₃ (FIG. 12b) seems to retard carbonation. Energy dispersive spectroscopy (EDS) reveals minor impurities of iron (Fe), which originates from the ball-milling, and MgO/MgCO₃ impurities from the commercial grade CaCO₃. The as-milled CaCO₃—Al₂O₃ sample (FIG. 12c) has particles similar to that of bulk CaCO₃ (i.e. FIG. 12a) but also has very small particles 100 nm), which is assigned to the hardness of Al₂O₃ that may assist in creating smaller particles during milling. After cycling, the bulk CaCO₃ turns into a maze of particles (FIG. 12d), but the presence of alumina as an additive, or additive precursor to form e.g. Ca₅Al₆O₁₄ and Ca₉Al₆O₁₈, may allow the separation of the CaO/CaCO₃ particles by the Al₂O₃. Both the CaCO₃ and CaCO₃—Al₂O₃ sample morphology is porous, which allows beneficial CO₂ diffusion through the particle structure. Furthermore, the as-milled CaCO₃—Al₂O₃ has specific regions with aluminium, i.e. Al₂O₃ (FIG. 12e), whereas the cycled sample (FIG. 12f) has aluminium more evenly distributed throughout the same areas as it formed an additive e.g. Ca₅Al₆O₁₄. In the CaCO₃—ZrO₂ sample (FIG. 12 g), the Zr appears to be well distributed in both the as-milled sample as ZrO₂ (FIG. 12j) and after cycling as CaZrO₃ (FIG. 12k). It is noted that the ZrO₂ contains a small impurity of Hf.

Perspectives/Outlook/Thermal Battery

A cost comparison of the proposed TOES materials, CaCO₃, and the state-of-the-art molten salt technology is provided in Table 3. The $3000/tonne price of ZrO₂ makes the price per terajoule in the CaCO₃—ZrO₂ (40 wt. %) system significantly more expensive than the state-of-the-art molten salts. However, Al₂O₃ is more abundant and thus cheaper, i.e. $376/tonne. Hence, the materials cost can be reduced by ˜95% per terajoule electrical energy produced if the molten salt is replaced with CaCO₃—Al₂O₃ (20 wt. %). The operating pressure of <6 bar CO₂ reduces the engineering challenges and costs, while the CO₂ may be stored in a zeolite or activated carbon by physisorption, which removes the energy demanding compression of the CO₂ gas during storage. Supercritical CO₂ may be utilised as the heat transfer fluid at 900° C., which makes it compatible with, e.g. the Rankine-Brayton combined cycle or the Stirling engine. The latter is highly efficient at 900° C. (theoretically η˜72%). Overall, the high energy density storage material and small footprint may enable the utilisation in Stirling dishes, which are dispatchable and may thus be ideal for remote areas with a requirement for power, e.g. minesites. Further, the thermal battery enables seasonal storage of a wide variety of renewable energy from, e.g. wind mill farms, photovoltaics, and CSP plants. The disclosed thermal battery, may maintain a 90% capacity up to 500 cycles, comparable to Li-ion batteries, which typically reach a capacity of 80%, defined as the batteries cycle life, after 1000 to 4500 cycles, corresponding to a lifespan between 7 and 20 years. Finally, the disclosed thermal battery may hold important safety features: (i) the chemical reactions are limited by equilibrium pressure, which prevents the reactions from running wild; (ii) hot, corrosive fluids, e.g. molten salt, is not present; and (iii) the compounds are not flammable.

TABLE 3
Cost comparison of materials

| | Molten Salt | CaMg(CO₃)₂ ⇄ | | CaCO₃ ⇄ | CaCO₃ ⇄ |
|---|---|---|---|---|---|
| | (40 NaNO₃: | MgO + | CaCO₃ ⇄ | CaO + CO₂ + | CaO + CO₂ + |
| | 60 KNO₃) | CaCO₃ + CO₂ | CaO + CO2 | 40 wt. % ZrO₂ | 20 wt. % Al₂O₃ |
| Enthalpy ΔH (kJ/mol) | 39.0 | 125.8 | 165.5 | 165.5^{a} | 165.5^{a} |
| Molar Mass (g/mol) | 94.60 | 184.40 | 100.09 | 100.09^{a} | 100.09^{a} |
| Density (g/cm³) | 2.17 | 2.85 | 2.71 | 2.71^{a} | 2.71^{a} |
| Capacity (wt. % CO₂) | — | 23.9 | 44.0 | 44.0^{a} | 44.0^{a} |
| Gravimetric Energy Density (kJ/kg) | 413 | 682 | 1657 | 1657^{a} | 1657^{a} |
| Volumetric Energy Density (MJ/m³) | 895 | 1944 | 4489 | 4489^{a} | 4489^{a} |
| Operating Temperature Range (° C.) | 290-565 | ~590 | 900 | 900 | 900 |
| Carnot Efficiency (%) | 46 | 65 | 74 | 74 | 74 |
| Estimated Practical Efficiency (%) | 27 | 41 | 49 | 49 | 49 |
| Mass Required (tonnes) | 9100 | 3598 | 1228 | 6385 | 3250 |
| Volume Required (m³) | 4194 | 1262 | 453 | 1863 | 1124 |
| Materials Cost ($/tonne)^{b} | 630 | 50 | 10 | 1206 | 83 |
| Total Materials Cost Required ($) | 5,733,289 | 179,887 | 12,298 | 7,700,530 | 270,397 |

^{a}Relates only to the active CaCO₃ part of the sample;
^{b}as of 2019.

Conclusion

A series of twelve CaCO₃-additive systems have been systematically investigated. The CaCO₃ is observed to decompose between 763° C.-851° C. depending on the additive, which is attributed to the size effects after ball-milling. Neat CaCO₃ has a capacity retention of ˜15% after 50 calcination/carbonation cycles. However, addition of ZrO₂ (40 wt. %) or Al₂O₃ (20 wt. %) shows the remarkable ability to enable an 80% CO₂ retention over >100 cycles with fast kinetics and where the sample is fully calcined/carbonated within 1 hour. Hence, the disclosed system may be suitable for use as a thermochemical energy storage material in a thermal battery operating at 900° C., which offers higher Carnot efficiency compared to other forms of thermal batteries, while the materials cost and footprint is significantly lowered, e.g. 95% of the materials cost.

### Example—Scale-up of a CaCO₃—Al₂O₃ (16.7 wt %) System

A scale-up of the CaCO₃-Al₂O₃ (16.7 wt %) system to 3.2 kg of material was investigated in three different configurations:
(i) activated carbon was utilised as a CO₂ storage material and thermally controlled to regulate the calcination and carbonation reaction through a generated pressure gradient. Furthermore, the thermodynamic equilibrium pressure of CaCO₃ was varied in a first scenario through lowering of the temperature to 850° C. upon carbonation and raising it to 950° C. upon calcination.
(ii) the sample temperature is kept constant at 900° C. while utilising the activated carbon storage method.
(iii) the activated carbon was substituted with a compressor to achieve a significant under/overpressure upon calcination/carbonation, i.e. 0.5 bar and 5-6 bar, respectively, compared to the 1 bar equilibrium pressure at 900° C.

Scenarios (i) and (iii) showed a 64% energy capacity retention at the end of a 10th cycle. The decrease in capacity was assigned to the formation of Mayenite, Ca₁₂Al₁₄O₃₃, which was considered an unwanted by-product.

Finally, a 316 L stainless-steel reactor was investigated to establish corrosion issues when treated under CO₂ atmosphere and 850° C. for approximately 1400 hours. X-ray diffraction reveal oxidation of the exterior of the reactor to Fe₂O₃, while the interior seems intact as Fe₃O₄.

Sample Preparation

3011 g of CaCO₃ (Sigma-Aldrich, >99.0%) was hand-mixed with 603.71 g of Al₂O₃ (Sigma-Aldrich, Puriss. 98%), i.e. in a 16.7 wt % ratio, before it was poured into a 10 L plastic container and shaken thoroughly together. The powder was then mixed/milled continuously for 1 hour in batches of ˜250 g in a custom-made 650 mL 316 stainless-steel vial containing 55 stainless-steel balls, o.d.=10 mm and m=465.2 g, using a Glen Mills Turbula T2C shaker mixer operating at 160 RPM.

Powder X-Ray Diffraction

In-house powder X-ray diffraction (XRD) was performed on a Bruker D8 Advance diffractometer equipped with a CuKα_{1,2} source in flat-plate geometry mode. Data were collected using a Lynxeye PSD detector in the 2θ-range 10-80° in steps of 0.02°. The phases were identified using the EVA Bruker software and the International Centre for Diffraction Data (ICDD) PDF4 database. The diffraction peaks were quantitatively analysed by the Rietveld method using the Bruker TOPAS Version 5 software.

Scanning Electron Microscopy

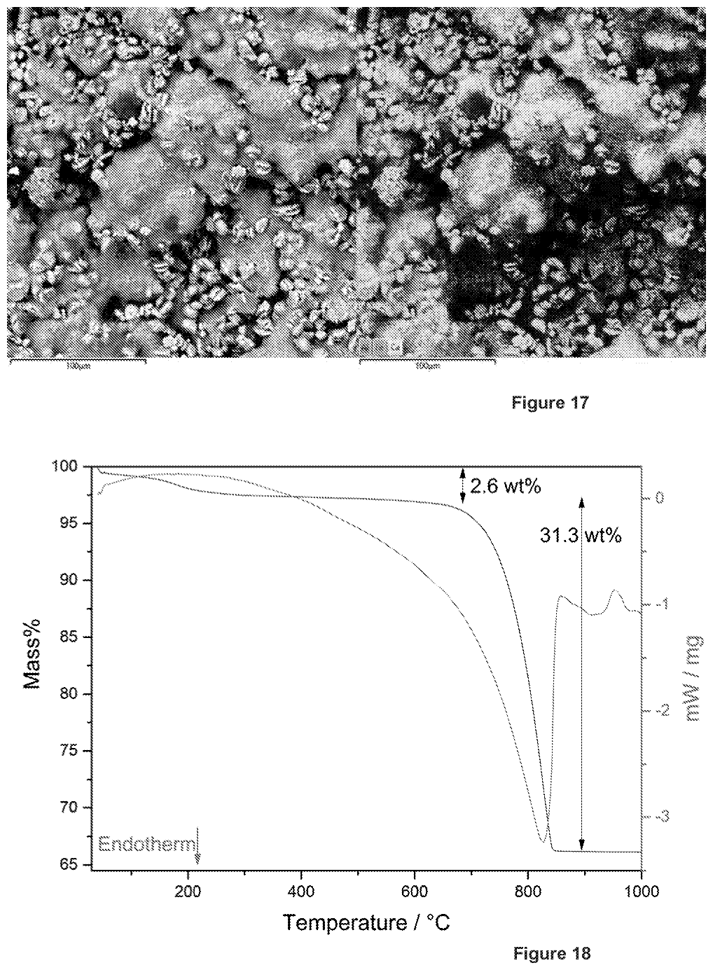

Scanning electron microscopy (SEM) and energy dispersive spectroscopy (EDS) were performed on a Tescan Mira3 FESEM coupled with an Oxford Instruments X-Max SDD X-ray detector and AZtec software. SEM images were collected using a secondary electron (SE) and backscattered electron (BSE) detector, an accelerating voltage of 20 kV, and a working distance of ˜15 mm. SEM samples were prepared by either depositing powders onto a stub or embedding samples in an epoxy resin, which was polished using colloidal silica. Eventually the samples were sputter-coated with a 10 nm thick carbon layer before imaging (FIG. 17).

Thermal Conductivity Analysis

A TPS 500S (Hot Disk, Thermtest) was used for thermal analysis, featuring a double nickel spiral sensor, laminated by electrically insulating Kapton. A C7577 (2 mm radius) sensor was employed and calibrated using stainless steel, polystyrene, and NaCl standards. A piece of the solid material obtained from the reactor, was polished to achieve a smooth surface, and thermal properties were measured 10 times on two different areas of a sample.

Pressure-Composition-Isotherm (PCI)

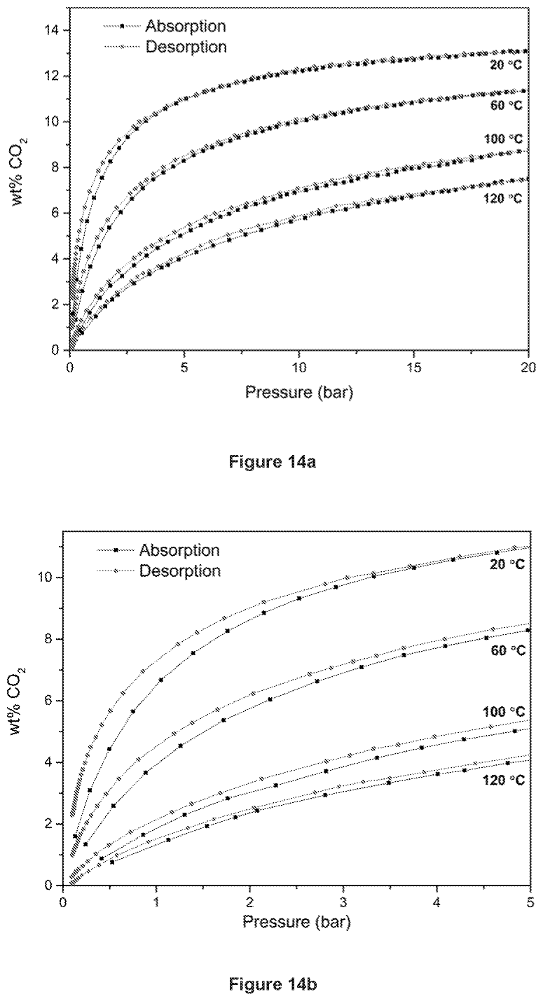

Pressure-composition-isotherm experiments were performed on activated carbon to determine the CO₂ storage properties of the material. The sample, 2.0252 g of activated carbon, was placed into a stainless-steel high-temperature sample cell, which was attached to a custom-made Sieverts' apparatus. An absorption and a desorption curve were obtained under isothermal conditions at T=20, 60, 100, and 120° C. by increasing/decreasing the pressure in steps of 1 bar (+/−0.5 bar) between p(CO₂)=1-20 bar at each temperature. The activated carbon was, in each pressure step, kept at the determined pressure for 30 minutes to reach an equilibrium (FIGS. 14a and 14b).

Design of Experimental Setup for CO₂ Cyclic Capacity Measurements

A custom-made 316L stainless-steel reactor (2″ tubing, i.d. 4.5 cm, length 138 cm, V=2194.8 cm³) was filled with 3197g of material, i.e. CaCO₃—Al₂O₃ (16.71 wt %). This resulted in 1792 g of active material, i.e. CaCO₃, when the reaction with Al₂O₃ was completed, see reaction scheme 2, and allowed for 788 g of CO₂ to be cycled. The stainless steel reactor was placed in a furnace (Furnace Technologies, model P44) capable of maintaining 900° C. for long periods of time, and connected to a custom made gas system. Thermocouples were installed at the gas inlet end of the reactor, in the middle, and at the far end of the gas inlet to monitor the temperature in different areas of the reactor as function of carbonation/calcination. The gas system was built from standard Swagelok connections and consisted of a CO₂ inlet, blow-off, and vacuum outlet, which allowed the system to be evacuated for moisture and to load it with CO₂ gas. The absolute pressure and differential pressure across an orifice (diameter 0.75 mm) between the CO₂ storage gas bottles and the stainless-steel reactor was measured by a Rosemount pressure transmitter (3051SMV). The measured flow rate allowed calculations of the mass flow of CO₂ and thus the CO₂ capacity of the CaCO₃ over multiple cycles, through the equation:

$${q}_{m} = \frac{C}{\sqrt{1 - {β}^{4}}} \cdot ε \cdot \frac{π}{4} {d}^{2} \cdot \sqrt{2 Δ p \cdot {ρ}_{1}} \qquad ( eq 1 )$$

where C is the discharge coefficient, β is the ratio between the orifice and pipe diameter (0.16), ε the expansibility factor (˜1), d is the orifice diameter (0.075 cm), Δp the differential pressure in Pa, and ρ is the gas density (ref. I. Bell, NIST Reference Fluid Thermodynamic and Transport Properties Database (REFPROP) Version9-SRD 23, National Institute of Standards and Technology).

In scenario 3, an installed pressure transmitter (Rosemount 3051S) on the gas bottle side was used to calculate the amount of moles of CO₂ in the gas bottles, based on the real gas law, pv=nRTZ, and eventually the mass of CO₂ in and out of the bottles. Once connected to the gas system, the CaCO₃ reactor was heated to 150° C. in vacuo for 48 hours to eliminate moisture in the system whilst tubing was thoroughly heated with a heat gun. Three different scenarios were evaluated where the CO₂ storage and reactor temperature were varied:

CO₂ Storage in Activated Carbon:

In Scenario 1 and 2, ˜20 kg of activated carbon was used for controlling the CO₂ pressure by varying the temperature of the activated carbon between 20° C. (lowering CO₂ pressure resulting in calcination of the CaCO₃) and 110° C. (increasing CO₂ pressure resulting in carbonation of CaO), which uptook/released about -4.1 wt % CO₂, see FIGS. 14a and 14b. The activated carbon was kept inside aluminium bottles (gas bottle 1 and 2, V=14.7 L each), which were heated/cooled by a Huber CC-505 water bath set to 15 or 120° C. in 12 h intervals (3 hours for heating or cooling and 9 hours maintaining the set temperature). Thermocouples were placed on the outside of the gas bottles, which were further insulated by 200 mm wool. Similar to the CaCO₃ reactor, vacuum was applied to the activated carbon vessels while heating them to 125° C. for 48 hours to eliminate the presence of moisture in the system.

Scenario 1: The temperature of the activated carbon was varied between 20 and 110° C., while the temperature of the material was varied between 850 and 950° C. (1 hour for heating/cooling and 11 hours at the set temperature) to create the largest driving force for calcination/carbonation.

Scenario 2: The temperature of the activated carbon was varied between 20 and 110° C., while the temperature of the material is kept constant at ˜900° C.

Before initiating scenario 3, the CaCO₃/Al₂O₃-material was fully ‘charged’ by applying ˜4 bar of CO₂ pressure for ˜10 days.

CO₂ storage in Pressure Vessels:

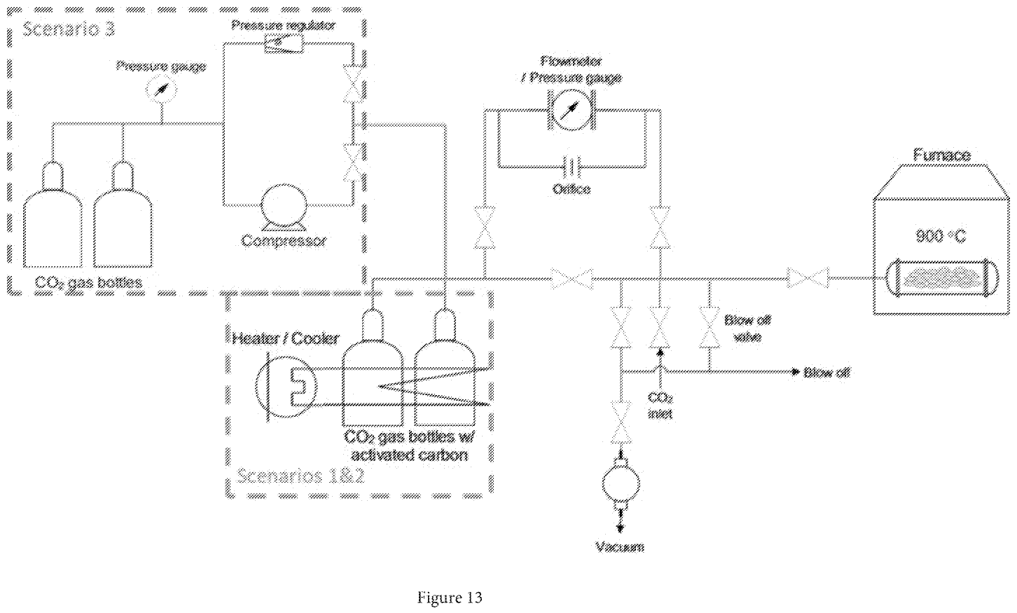

Scenario 3: A CO₂ compressor (HASKEL 86990), a pressure transmitter (Rosemount 3051S), and a pressure regulator was installed between the CO₂ gas storage bottles and the pressure transmitter/reactor, see FIG. 13, which were utilised to keep the calcination pressure below 0.7 bar and apply ˜5-6 bar on the sample for carbonation.

Results & Discussion

Energy Storage Capacity

Scenario 1: This scenario represented a large thermodynamic driving force for calcination and carbonation due to the temperature fluctuation of the furnace, i.e. the CaCO₃—Al₂O₃ material. Despite the large driving force, the CO₂ capacity, i.e. the energy capacity, degraded over the 10 cycles from 732 g CO₂ (of the theoretically 788 g CO₂, 92.9%) to 483.7 g CO₂ (61.4%) on calcination. Although, the last four cycles fluctuated slightly around 500 g of CO₂ (63-64%). The decrease in capacity to around 63% was explained by the two different kinetic regions observed, where the slowest kinetics appeared to be dominating above 350 g of CO₂ absorbed. Self-heating of the material may degrade the capacity during rapid CO₂ absorption. Thus, within the timeframe of the experiment, the sample was not able to absorb more than 63% of the full capacity. The slow reaction kinetic region may be overcome by applying a CO₂ overpressure (as highlighted in scenario 3), but the pressure provided from the activated carbon may simply not be sufficient to provide adequate kinetics, despite the decrease in equilibrium pressure at 850° C.

Scenario 2: The influence of maintaining the sample (CaCO₃/Al₂O₃) temperature constant at 900° C. was reflected in the absorption kinetics, which appeared slower, probably due to the higher equilibrium pressure at 900° C. (compared to absorption at 850° C.) and thus the smaller overpressure that may restrict the reaction kinetics. The CO₂ cycling was initiated with a limited carbonation that reached 383.68 g CO₂ (46.79%) and a subsequent calcination ending at 420.72 g CO₂ (53.39%), which indicated a fraction of CO₂ left from the first scenario. The CO₂ capacity gradually dropped throughout the cyclic measurements ending at a CO₂ release of 276.64 g (35.11%). In comparison with scenario 1 the second scenario displayed slower reaction kinetics, which was assigned to the smaller driving force created when maintaining the sample temperature at 900° C. This further caused the CO₂ capacity to gradually decrease.

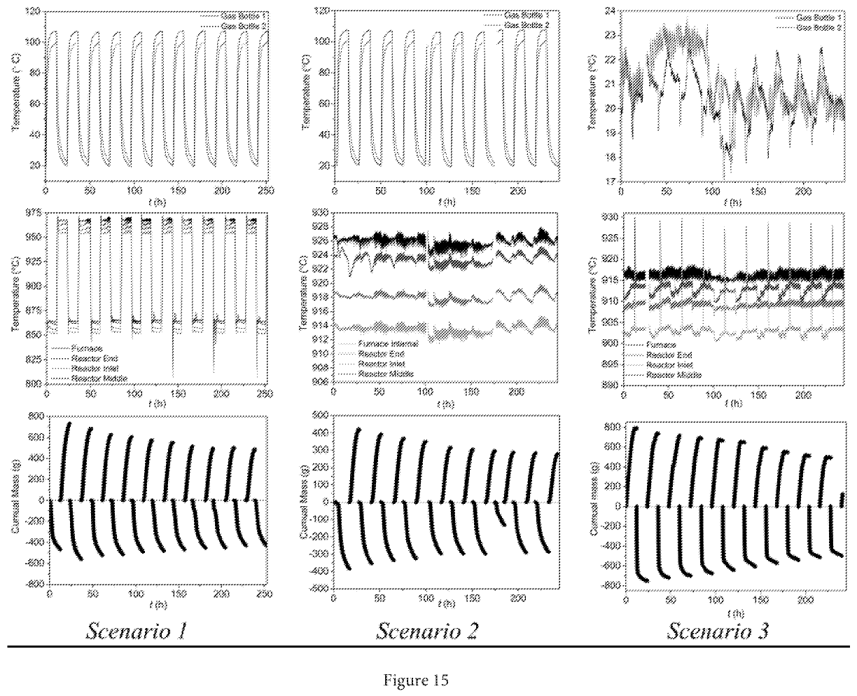

Scenario 3: The full CO₂ capacity of the material was restored before initiating this scenario. The first calcination showed full CO₂ desorption, i.e. 788 g of CO₂ was released. Subsequently, 750 g of CO₂ (˜95.2% capacity) was absorbed during the first carbonation, whereas the capacity slightly decreased throughout the 10 cycles. The calcination curves plateaued, whereas the carbonation curves did not finish within the timeframe. Again, this was assigned to the second reaction kinetics regime, which was much slower compared to the initial process. The capacity ended up with a carbonation at 499.3 g CO₂ (63.4%), which is similar to Scenario 1. A comparison of the different scenarios is shown in FIG. 15. In FIG. 15, the top row shows the variation in gas bottle temperature, the middle row shows the variation in furnace temperature applied to the stainless-steel reactor, while the bottom row shows the CO₂ capacity in each scenario.

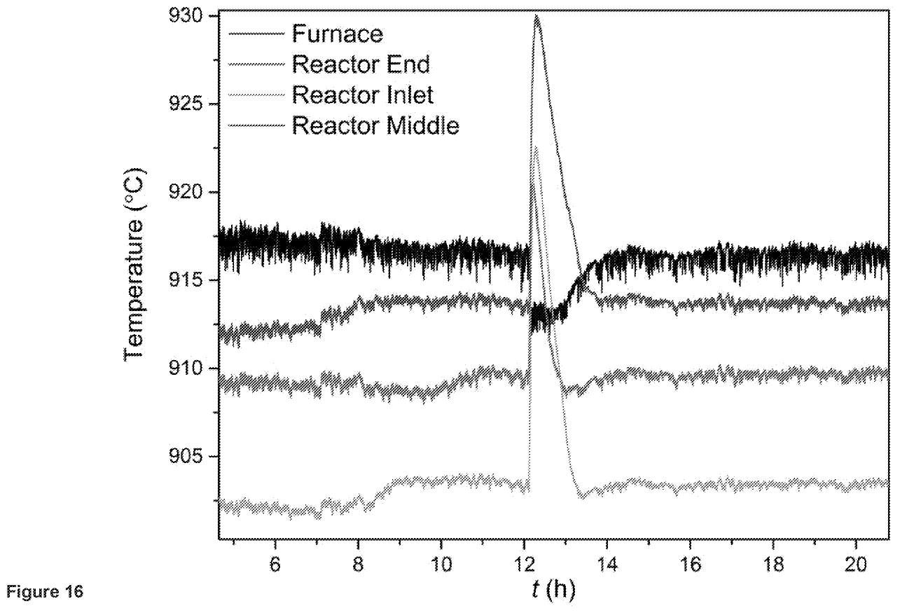

Thus, the applied CO₂ over/under pressure during carbonation/calcination had a similar effect compared to variations in the calcination/carbonation temperature. However, the CO₂ over-pressure resulted in rapid temperature spikes during absorption (increase up to 22° C. on the outside of the reactor, see FIG. 16), which were not observed in the two previous scenarios due to the CO₂ pressure being close to equilibrium pressure, hence the reaction kinetics were slower.

Sample Composition from X-Ray Diffraction

The sample composition was evaluated after Scenario 3 by X-ray diffraction at three different spots in the reactor, i.e. at the reactor gas inlet, the reactor middle, and the far end of the reactor. At this point the CO₂ capacity has degraded to ˜64%. Powder samples were prepared by grinding the compacted samples. Furthermore, the stainless-steel from the reactor was investigated to establish any degradation from being in CO₂ atmosphere over a long period of time (approx. 1400 hours) at T˜900° C., see Table 4. Interestingly, the reactor inlet possessed the largest amount of CaCO₃ and CaO, 46.0(2) and 10.1(9) wt %, respectively, and the lowest amount of the by-product Mayenite, Ca₁₂Al₁₄O₃₃ (33.4(2) wt %), although this contributed to almost a third of the sample composition. In the middle of the reactor the content of Mayenite was 49.8(2) wt %, whereas the content of CaCO₃ and CaO was 32.1(2) and 18.1(1) wt %, respectively. At the end of the reactor, 42.0(2) wt % of Mayenite was observed with only 49.3(2) wt % of CaO. The expected compound, Ca₅A₁₆O₁₄, was only identified at the inlet and in the uncompacted powder at the end of the reactor (10.6(3) and 7.2(2) wt %, respectively), whereas it was not observed in the middle of the reactor. The composition results reveal that the capacity decrease observed was partly due to the formation of large fractions of Mayenite throughout the reactor due to the consumption of CaO (reaction scheme 2) compared to the expected product (reaction scheme 1).

5CaCO₃(s)+3Al₂O₃(s)→Ca₅Al₆O₁₄(s)+5CO₂(g) (1)

7Ca₅Al₆O₁₄(S)+CaO(S)→3Ca₁₂Al₁₄O₃₃(s) (2)

TABLE 4
Sample composition (wt %) extracted from Rietveld refinement of PXD data.

| | | | | | Stainless | Stainless |
|---|---|---|---|---|---|---|
| | Material at | Material at | Material at | Material | Steel | Steel |
| | Reactor | Reactor | Reactor | Compacted at | reactor | reactor |
| Compound | Inlet | middle | End | Reactor End | inside | Outside |
| CaCO₃ | 46.0(2) | 32.1(2) | — | 49.3(2) | 1.6(3) | — |
| CaO | 10.1(9) | 18.1(1) | 45.6(1) | 3.0(8) | — | — |
| Ca₅Al₆O₁₄ | 10.6(3) | — | 7.2(2) | — | — | — |
| Ca₁₂Al₁₄O₃₃ | 33.4(2) | 49.8(2) | 47.2(1) | 42.0(2) | — | — |
| Ca(OH)₂ | — | — | — | 5.8(1) | — | — |
| Fe₃O₄ | — | — | — | — | 98.4(3) | — |
| α-Fe₂O₃ | — | — | — | — | — | 58.4(7) |
| γ-Fe₂O₃ | — | — | — | — | — | 41.6(7) |

Throughout the experiment it was noted that the exterior of the 316L Stainless Steel tube was flaking. Logically this was understood to be oxidation of the tube at high temperature. XRD analysis verified that the flakes were composed of α-Fe₂O₃ (Hematite—58.4(7)) and γ-Fe₂O₃ (Maghemite—41.6(7) wt %. In contrast, the interior of the tube had also undergone reaction with the XRD identifying Fe₃O₄ (Magnetite) as well as some CaCO₃ and a minor unknown phase.

Conclusions
A 3 kg scale-up system was demonstrated utilising three different running scenarios.
Varying the sample temperature between 850 and 950° C. created a thermodynamic driving force, which proved as good as varying the applied CO₂ pressure between 0.5 and 5-6 bar during calcination/carbonation, respectively, while keeping the sample at 900° C.
Although, the energy capacity decreased over the 10 cycles applied here at real-life conditions (12 h calcination and carbonation), reaching a level of ˜60%. The capacity drop was assigned to either excessive self-heating during CO₂ absorption and/or the excessive formation of Mayenite, Ca₁₂Al₁₄O₃₃, which has previously been observed at temperatures above 1000° C., but the formation may be possible at a 950° C. operating temperature.
Making CO₂ compression superfluous increases the overall energy efficiency of the system when removing the energy penalty of compression (8-20% of the overall energy balance).
Activated carbon proved sufficient as a CO₂ storage system

### Example—Adding Mixtures of Oxides to Limestone (CaCO₃)

The effect of adding both Al₂O₃ and ZrO₂ to limestone (CaCO₃) to enhance the cyclic stability and reaction kinetics of endothermic CO₂ release and exothermic CO₂ absorption was investigated.

### EXPERIMENTAL

Sample Preparation

Two individual samples were produced by mixing CaCO₃ (Sigma-Aldrich, >99.0%) with Al₂O₃ (nanopowder, 13 nm (TEM), 99.8% purity; 20 wt %, i.e. ˜4 g CaCO₃ and ˜1 g Al₂O₃) and ZrO₂ (Sigma-Aldrich, nanopowder, <100 nm; 40 wt %, i.e. ˜3 g CaCO₃ and ˜2 g ZrO₂). 10 mL of ethanol (CH₃CH₂OH) was added to the samples, which were then ball-milled in stainless steel vials for 2 hours (15 min milling×1 min pause×8 reps; 12×8 mm stainless steel balls). After ball milling, the samples were placed in an oven at 105° C. for approximately 1 hour to obtain a dry powder. Finally, the two samples were hand ground together in a 2:1 ratio (Al₂O₃:ZrO₂ sample; 0.8 and 0.4 g, respectively) to obtain 1.2 g of CaCO₃—Al₂O₃—ZrO₂ sample with ˜13.3 wt. % of each additive.

Thermogravimetric and Differential Scanning Calorimetry Analysis

Thermogravimetric and simultaneous differential scanning calorimetry (TG-DSC) analysis was performed on a Mettler Toledo DSC 1 instrument as shown in FIG. 18 The samples were heated from room temperature to 1000° C. (ΔT/Δt=10° C. min⁻¹) under an argon flow (20 mL min⁻¹) in alumina crucibles.

Sieverts Experiments

The CaCO₃—Al₂O₃—ZrO₂ sample (0.2979 g) was loaded into a SiC sample cell, which was attached via Swagelok parts to a custom-made manometric Sieverts apparatus (https://doi.org/10.1016/j.jallcom.2019.02.067.). The sample was heated to ˜895° C. (ΔT/Δt=5° C. min⁻¹) at p(CO₂)=10⁻² bar, thus decomposing the sample. Subsequently, cycling of the sample was initiated at isothermal conditions (˜895° C.) with carbonation at P_{average,carbonation}(CO₂)˜5.2 bar(±0.6 bar) for 30 minutes in a 55.8 cm³ volume, followed by calcination at p_{average,calcination}(CO₂)˜0.75 bar for 30 minutes in a 206.1 cm³ volume. A total of 50 cycles of isothermal CO₂ absorption and desorption were collected. Finally, the sample was carbonated and cooled to room temperature under p(CO₂)˜5 bar. The data had been scaled according to reaction (3) and (4) occurring, leaving a 40.7 wt % CaCO₃ quantity, which was the active component:

CaO(s)+ZrO₂(s)→CaZrO₃(s) (3)

5CaO(s)+3Al₂O₃(s)→Ca₅Al₆O₁₄(s) (4)

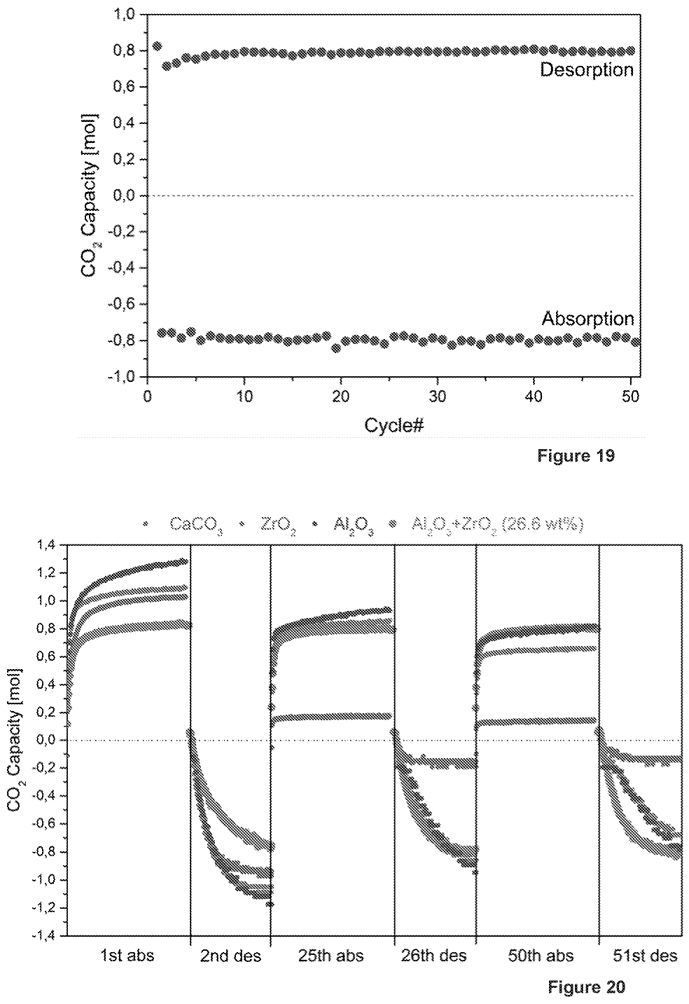

Thus, the fractional capacity in FIGS. 19 and 20 were based on 1 mole of CO₂ being released/absorbed according to reaction scheme 5.

CaCO₃(s)⇄CaO(s)+CO₂(g)ΔH_{890° C.}=165.7 kJ; ΔS_{890° C.=}143.0 J/K; ΔG_{890° C.≈}0 kJ (5)

Powder X-Ray Diffraction

In-house powder X-ray diffraction (XRD) was performed on a Bruker D8 Advance diffractometer equipped with a CuKα_{1,2} source in flat-plate geometry mode (FIG. 21). Data were collected using a Lynxeye PSD detector in the 2θ-range 15-60° in steps of 0.02°.

In Situ Synchrotron Radiation Powder X-Ray Diffraction

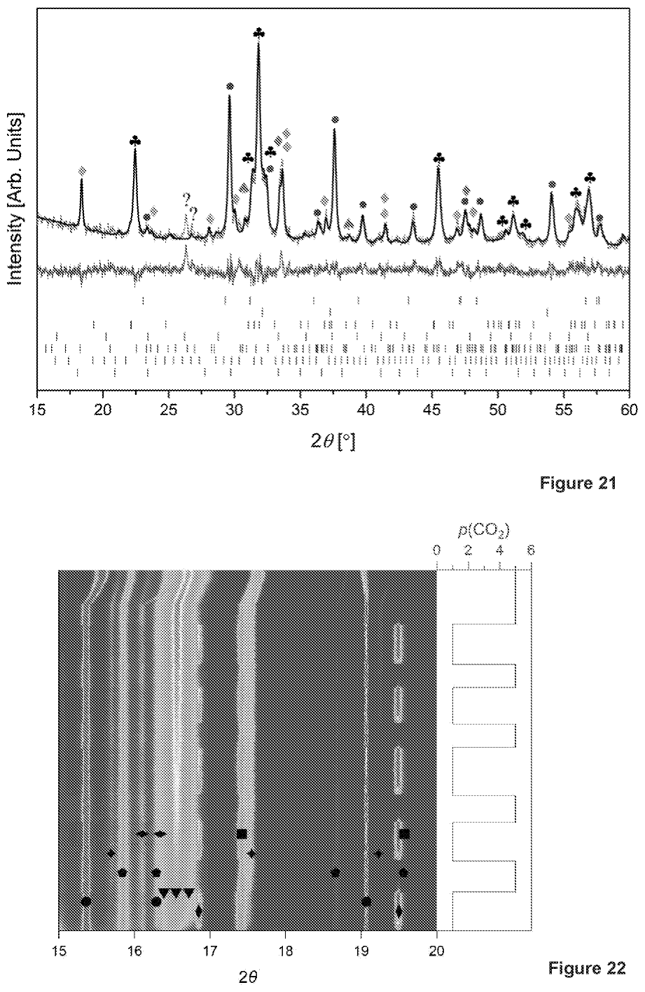

In situ time-resolved Synchrotron Radiation Powder X-ray Diffraction (SR XRD) data were collected at the Powder Diffraction beamline at the Australian Synchrotron, Melbourne, Australia on a Mythen microstrip detector at λ=0.825018 (ref. https://doi.org/10.1063/1.2436201, https://doi.org/10.1016/S0168-9002(02)02045-4) . The powdered sample was loaded into a quartz capillary (i.d.=0.5 mm, o.d.=0.6 mm), which was attached to a gas system enabling control of CO₂ pressure. The sample was inserted into a hot air-blower operating at 917° C. while oscillating during data acquisition. After five CO₂ cycles, the sample was cooled to room temperature at ΔT/Δt=50° C. min⁻¹ under p(CO₂)=5 bar. Temperature calibrations were performed using the well-known thermal expansion of NaCl and Ag (ref. https://doi.org/10.1107/S1600576715011735, https://doi.org/10.1063/1.1901803) (FIG. 22).

Scanning Electron Microscopy

Scanning electron microscopy (SEM) and energy dispersive spectroscopy (EDS) were performed on a Tescan Mira3 FESEM coupled with an Oxford Instruments X-Max SDD X-ray detector and AZtec software. SEM images were collected using a backscattered electron (BSE) detector, an accelerating voltage of 20 kV, and a working distance of ˜15 mm. SEM samples were prepared by placing powder onto double-sided conductive carbon tape on a 12.6 mm aluminium sample mount. Excess powder was removed by a passing a light flow of argon gas over the sample. Samples were then sputter-coated with a 3 nm thick platinum layer before imaging.

Small-Angle X-Ray Scattering

Small angle X-ray scattering (SAXS) data was collected on a Bruker Nanostar instrument equipped with an Excillium MetalJet source (GaK_{α}, λ=1.3402 Å). Sample powders were pressed between polymer films in transmission geometry and measured under vacuum. Data were background subtracted and put onto an absolute scale using a NIST SRM3600 glassy carbon standard (ref. https://doi.org/10.1107/S0021889803002279). Specific surface area (SSA) was calculated from the high-q Porod region (power law slope=−4) using the Unified model in the Irena software package for Igor Pro (WaveMetrics) (ref. https://doi.org/10.1107/S0021889895005292, https://doi.org/10.1107/S0021889809002222). This was calculated through:

$$SSA = \frac{B}{2 {πδΔρ}^{2}} \qquad ( eq . 2 )$$

where B is Porod's constant refined in the Unified fit, δ is the crystallographic density, and Δρ² is the scattering contrast between the powder (density of 3.05 g/cm³, linear attenuation coefficient of 223 cm⁻¹) and vacuum.

Results & Discussion

Thermal Analysis

Thermal analysis of as-prepared CaCO₃—Al₂O₃—ZrO₂ revealed a small mass loss (2.6 wt. %, see FIG. 18) between room temperature and 250° C., which was assigned to evaporation of moisture from the sample, as no reaction was expected in this temperature range. At ˜650° C., a one-step endothermic decomposition initiated with a total mass loss of 31.3 wt % completed by ˜850° C., which was close to the theoretical mass loss expected due to CO₂ release (32.2 wt %). The observed decomposition temperature was typical for CaCO₃ and further reactions with ZrO₂ and Al₂O₃ occurred with the decomposition product, CaO (reaction scheme 3 and 4), without further mass loss (ref. https://doi.org/10.3390/app9214601, https://doi.org/10.1039/DOTA03080E).

Thermochemical CO₂ Pressure Cycling

The CaCO₃—Al₂O₃—ZrO₂ sample had a minor initial drop in the expected CO₂ capacity between the first and second cycle (from 82.5% to 71.4%, see FIG. 19, 1 mole CO₂=100% theoretical capacity, which was calculated from reaction scheme (3) and (4) as 40.7% CaCO₃ was the active portion of the sample). However, the system recovered and showed promise by stabilising at 80% capacity and maintaining it throughout the remaining cycles. The full thermochemical capacity (i.e. 1 mol of CO₂) was calculated based on the initial amount of CaCO₃ and assuming that the additives fully reacted with the CaCO₃ (reaction 3 and 4), where the cyclable CaCO₃ content reached 40.7 wt. % of the entire sample mass. The thermochemical system showed rapid reaction kinetics as the 8% capacity was charged/discharged within 30/20 minutes, respectively. FIG. 20 compares the reaction kinetics of pristine CaCO₃, CaCO₃—Al₂O₃ (20 wt %), and CaCO₃—ZrO₂ (20 wt %), along with the CaCO₃—Al₂O₃—ZrO₂ sample (ref. https://doi.org/10.1039/DOTA03080E). In FIG. 20, the calcination/carbonation (des/abs) cycle is given on the x-axis: t_{abs}=30 min, p_{abs}˜5.2 bar, t_{des}=20 min, p_{des}˜0.75 bar. The data was corrected according to reaction schemes (3) and (4) taking place. The capacity exceeding 1 mol of CO₂ indicated that the initial reactions (3) and (4) were incomplete at this stage.

The ternary CaCO₃—Al₂O₃—ZrO₂ system showed rapid absorption kinetics throughout all 50 cycles. In particular, the CO₂ desorption kinetics in the ternary CaCO₃—Al₂O₃—ZrO₂ system became superior to the other systems as cycling increased, overcoming a previous kinetic degradation issue observed in the binary systems. Finally, the cyclic capacity after 50 cycles was ˜81% for CaCO₃—Al₂O₃—ZrO₂ compared to ˜78% and ˜68% for the CaCO₃—Al₂O₃ and CaCO₃—ZrO2 samples, respectively (ref. https://doi.org/10.1039/DOTA03080E).

Composition

The composition of CaCO₃—Al₂O₃—ZrO₂ after 50 cycles (in the desorbed state) was identified by XRD (see FIG. 21). The diffraction pattern revealed that CaCO₃ was present, which was assigned to partial CO₂ absorption during cooling of the sample. In FIG. 21, markers: CaCO₃ (brown dot); CaO (blue dot); CaZrO₃ (clover); Ca₃Al₂O₆ (green diamond); Ca₅Al₆O₁₄ (purple spade); Ca₉Al₆O₁₈ (red diamond); Ca₁₂Al₁₄O₃₃ (Mayenite, orange diamond); unknown (question mark). Rietveld refinement of the Powder X-ray diffraction data. Y_{obs}: red; Y_{calc} : black, and Y_{diff}: blue. hkl Markers from the top to the bottom: CaCO₃ (top), CaO, CaZrO₃, Ca₃Al₂O₆, Ca₅Al₆O₁₄, Ca₉Al₆O₁₈, and Ca₁₂Al₁₄O₃₃ (bottom). R_{wp}˜9.17%.

Furthermore, the decomposition product CaO was present along with the expected reaction products CaZrO₃ and Ca₅Al₆O₁₄ but also by-products Ca₃Al₂O₆ and Ca₉Al₆O₁₈. The compounds Ca₃Al₂O₆ and Ca₅Al₆O₁₄ were intermediates on the pathway to form Mayenite, i.e. Ca₁₂Al₁₄O₃₃, which was also identified in the sample (ref. https://doi.org/10.3390/ma12010084). The decrease in capacity, i.e. to the retained 80% over 50 cycles, was assigned to the side reaction producing Mayenite (and partially Ca₉Al₆O₁₈), which was only observed in a limited amount in a previous study with better capacity retention (ref. https://doi.org/10.1039/DOTA03080E).

The in situ SR XRD data (FIG. 22) initially showed the rapid formation of CaO at 917° C., which indicated the decomposition of CaCO₃ under 1 bar of CO₂ pressure. In FIG. 22 the pressure profile is indicated to the right of the figure. Carbonation was performed for ˜20 min and calcination for ˜30 min in a total of 5 cycles. The bottom of the figure signifies the start of the cycles. Intensity was indicated as blue: low and red: high. Markers: CaCO₃ (circle); CaZrO₃ (triangle); CaO (diamond); CaAl₂O₄ (pentagon); Ca₃Al₂O₆ (square); Ca₅Al₆O₁₄ (bowtie): Ca₁₂Al₁₄O₃₃ (star). The reaction can be observed most significantly by intensity increases/decreases for the CaO Bragg reflections as a function of the CO₂ pressure change, although, small alterations in the intensity of the Bragg reflection from CaCO₃ at 2θ=19.05° are also visible. Hence, CaO Bragg reflections quickly appear/disappear when CO₂ pressure is released/applied. Furthermore, the gradual but continuous formation of CaZrO₃ throughout the experiment was also evident in parallel with several Ca—Al—O compounds being observed, i.e. CaAl₂O₄, Ca₃Al₂O₆, Ca₅Al₆O₁₄, and Ca₁₂Al₁₄O₃₃. Mayenite, Ca₁₂Al₁₄O₃₃, seemed to be formed in a large fraction, which may be due to the difference in temperature between the synchrotron measurements and the cycling measurements, 917 vs. 900° C., respectively, which may influence thermodynamics and/or reaction kinetics of its formation.

Morphology and Specific Surface Area

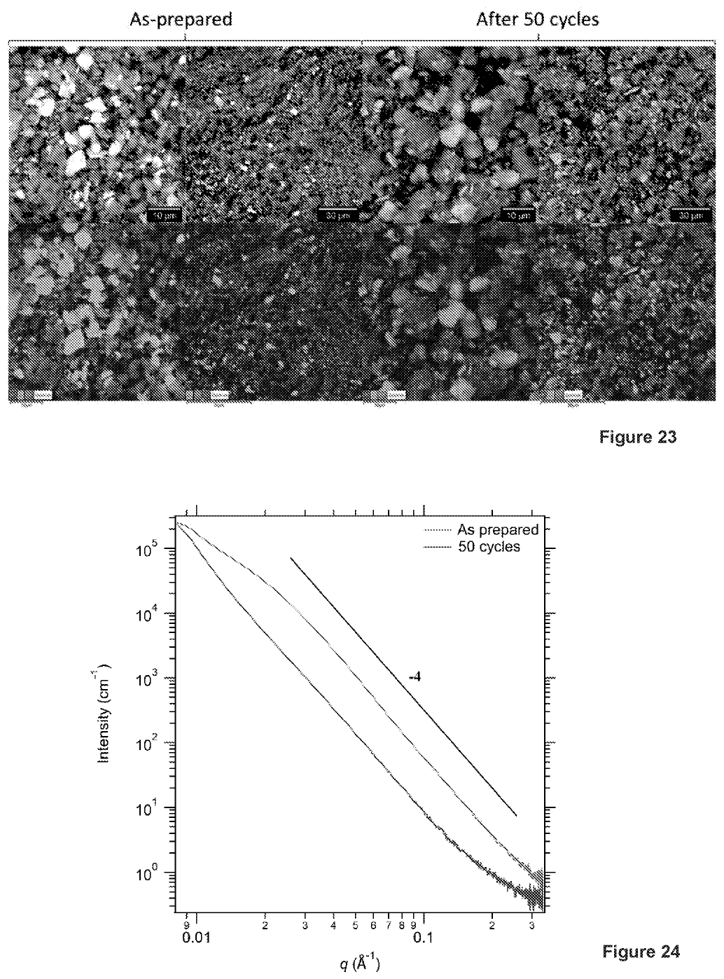

The morphology of the CaCO₃—Al₂O₃—ZrO₂ sample before and after cycling was evaluated through scanning electron microscopy (SEM), see FIG. 23 (EDS mapping colour code: Al: blue; Zr: green; Ca: red). From the EDS mapping it was evident that the as-prepared sample had calcium and aluminium finely dispersed throughout. However, large particles containing zirconium, i.e. ZrO₂ (˜4-10 μm) were present, likely due to its resistance to comminution given its extreme hardness (8-8.5 Mohs). The morphology did not change significantly after cycling, although, elemental zirconium was more dispersed, which was assigned to the formation of CaZrO₃ rather than ZrO₂. This finding also matched XRD results, where ZrO₂ was absent after cycling, hence the large Zr-rich particles (6-10 μm) must be CaZrO₃. Calcium and aluminium was still finely dispersed throughout the entire sample, which agreed with the observed formation of Ca—Al —O compounds. The multicomponent CaCO₃—Al₂O₃—ZrO₂ proved to have a very different morphology to CaCO₃ samples containing only one of the additives, i.e. CaCO₃—Al₂O₃ and CaCO₃—ZrO₂ (ref. https://doi.org/10.1039/DOTA03080E). The binary systems formed an interconnected molten-like morphology after cycling with some degree of porosity, which is not observed for the ternary mixture.

Comparison of the specific surface areas measured by SAXS (data presented in FIG. 24) indicated the large influence of the porous ZrO₂ added in the as-prepared samples, as the ternary sample had a much larger surface area than the as-milled CaCO₃—Al₂O₃(20 wt %) sample, but similar to the CaCO₃—ZrO₂(40 wt %) sample. Despite the observations by SEM, where the ternary CaCO₃—Al₂O₃—ZrO₂ system seemed to lack porosity in comparison with the CaCO₃—Al₂O₃(20 wt %) and CaCO₃—ZrO₂(40 wt %), the SAXS data for the ternary system showed that the surface area was approximately 2-6 times larger after cycling compared to the binary samples, see Table 5. The increased surface area was likely to play a key role in the observed higher cyclic CO₂ capacity retention, allowing CO₂ to be released and absorbed from a significantly greater portion of the material more easily.

TABLE 5
Comparison of the specific surface area between the binary systems
CaCO₃—Al₂O₃(20 wt %) and CaCO₃—ZrO₂(40 wt %) and the ternary
system CaCO₃—Al₂O₃(13.3 wt %)—ZrO₂(13.3 wt %).

| | Specific | | | |
|---|---|---|---|---|
| | Surface | | | |
| | Area | # CO₂ | | |
| Sample | (m² · g⁻¹) | cycles | Comments | Ref |
| CaCO₃—Al₂O₃ | 3.7(4) | 0 | As-milled | https://doi.org/10.1039/D0TA03080E |
| (20 wt %) | | | | |
| CaCO₃—Al₂O₃ | 1.2(1) | 50 | Absorbed | https://doi.org/10.1039/D0TA03080E |
| (20 wt %) | | | | |
| CaCO₃—ZrO₂ | 52(5) | 0 | As-milled | https://doi.org/10.1039/D0TA03080E |
| (40 wt %) | | | | |
| CaCO₃—ZrO₂ | 3.1(3) | 50 | Absorbed | https://doi.org/10.1039/D0TA03080E |
| (40 wt %) | | | | |
| CaCO₃—ZrO₂ | 50(5) | 0 | As-prepared | This Example. |
| (13.3 wt %)_{—} | | | | |
| Al₂O₃ | | | | |
| (13.3 wt %) | | | | |
| CaCO₃—ZrO₂ | 6(1) | 50 | Absorbed | This Example. |
| (13.3 wt %)— | | | | |
| Al₂O₃ | | | | |
| (13.3 wt %) | | | | |

Conclusions

The combination of adding both ZrO₂ and Al₂O₃ to CaCO₃ had a positive effect as a cyclic stability of >80% was achieved at rapid calcination/carbonation times, i.e. 20 and 30 min, respectively. The reaction kinetics were fast, especially during carbonation. However, the calcination kinetics improved as the sample was cycled. The cyclic stability was hypothesised to arise from a synergetic effect of having both CaZrO₃ and Ca—Al—O compounds present in the sample, by preventing sintering of CaO/CaCO₃ particles and improving reaction kinetics, even better than the individual binary systems. This effect was highlighted by the larger specific surface area observed in the ternary system after cycling and the different morphology of the cycled material. However, the excessive presence of large zirconium-rich particles suggested that a smaller quantity of ZrO₂ may be sufficient in achieving the same benefits whilst lowering the overall price of the system. This Example suggested that combining different active properties of additives/catalysts can enhance the cyclic stability of a metal carbonate even further. This opened up multiple new pathways for optimising the thermochemical energy storage properties of metal carbonates.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

It will be understood to persons skilled in the art of the current disclosure that many modifications may be made without departing from the spirit and scope of the disclosure.

1-34. (canceled)

35. A method of storing energy, comprising:
heating a material comprising a CO₂ sorbed product and an additive to desorb CO₂ from the material and convert the CO₂ sorbed product to a CO₂ sorbent;
wherein the additive at least partially prevents during heating:
(i) sintering of the CO₂ sorbent and/or the CO₂ sorbed product; and
(ii) the formation of a crust on the material, the crust minimising or preventing the CO₂ sorbent and CO₂ from reacting with one another to form the CO₂ sorbed product in a subsequent CO₂ absorption step; and
wherein both sorbing and desorbing are performed in a CO₂ atmosphere.

36. The method according to claim 35, wherein the CO₂ sorbent is CaO and the CO₂ sorbed product is CaCO₃.

37. The method according to claim 35, wherein the step of desorbing CO₂ from the material is performed at a temperature of 900° C. or higher.

38. The method according to claim 35, wherein the step of desorbing CO₂ from the material is performed at a temperature of lower than 1200° C.

39. The method according to claim 35, comprising mixing an additive precursor with the material which reacts with the CO₂ sorbent to form the additive.

40. The method according to claim 39, wherein the additive precursor includes Al₂O₃ and/or ZrO₂.

41. The method according to claim 35, wherein the additive is a metal oxide having at least one metal.

42. The method according to claim 35, wherein the additive includes CaZrO₃ and/or a calcium aluminate.

43. The method according to claim 35, wherein the additive includes Ca₅Al₆O₁₄ and Ca₉Al₆O₁₈.

44. The method according to claim 35, wherein a ratio of the additive to the CO₂ sorbed product ranges from about 10 wt. % to about 70 wt. %.

45. The method according to claim 35, wherein, during CO₂ absorption, the additive allows the CO₂ sorbent to migrate through the particle from an inner region of the particle to a surface of the particle to react with CO₂ present at the surface of the particle to form the CO₂ sorbed product.

46. The method according to claim 35, further comprising a step of sorbing CO₂ onto the CO₂ sorbent to reform the CO₂ sorbed product, thereby releasing energy.

47. The method according to claim 46, wherein desorbing CO₂ from the CO₂ sorbed product is carried out under a reduced pressure compared to a pressure used to sorb CO₂ to the CO₂ sorbent.

48. The method according to claim 35, wherein the CO₂ is provided as a gas or supercritical fluid.

49. The method according to claim 35, wherein the pressure used for CO₂ absorption and desorption is up to about 60 bar.

50. A composition used to sorb and desorb CO₂ in a thermal battery, comprising:
a form of calcium that is capable of absorbing or desorbing CO₂ to, respectively, form a CO₂ sorbed product or CO₂ desorbed product;
an additive having a concentration ranging from about 5 wt. % to about 95 wt. % relative an amount of the CO₂ sorbed product, wherein the additive includes Ca₅Al₆O₁₄ and/or Ca₉A₁₆O₁₈;
wherein the additive at least partially prevents upon heating of the composition sintering of the CO₂ sorbed/desorbed product and the formation of a crust that minimises or prevents the CO₂ desorbed product and CO₂ from reacting with one another to form the CO₂ sorbed product.

51. The composition according to claim 50, wherein a ratio of Ca₅Al₆O₁₄ to Ca₉Al₆O₁₈ ranges from about 100:0 to about 0:100.

52. A composition used to sorb and desorb CO₂ in a thermal battery, comprising:
a form of calcium that is capable of absorbing or desorbing CO₂ to, respectively, form a CO₂ sorbed product or CO₂ desorbed product;
an additive having a concentration ranging from about 5 wt. % to about 95 wt. % relative an amount of the CO₂ sorbed product, wherein the additive includes a mixture of Zr and Al oxides;
wherein the additive at least partially prevents upon heating of the composition sintering of the CO₂ sorbed/desorbed product and the formation of a crust that minimises or prevents the CO₂ desorbed product and CO₂ from reacting with one another to form the CO₂ sorbed product.

53. A system for storing energy, comprising:
a reactor comprising a CO₂ atmosphere and a material that is capable of absorbing or desorbing CO₂ to, respectively, form a CO₂ sorbed product or CO₂ desorbed product, the material having an additive that at least partially prevents during heating:
sintering of the CO₂ sorbent/sorbed product; and the formation of a crust on the material, the crust minimising or preventing the CO₂ sorbent and CO₂ from reacting with one another to form the CO₂ sorbed product; and
a CO₂ source that is in fluid communication with the reactor to allow a flow of CO₂ between the reactor and CO₂ source during absorption or desorption of CO₂, such that both sorbing and desorbing are performed in the CO₂ atmosphere in the reactor.

54. The system according to claim 53, wherein the material for the reactor comprises a composition comprising:
a form of calcium that is capable of absorbing or desorbing CO₂ to, respectively, form a CO₂ sorbed product or CO₂ desorbed product;
an additive having a concentration ranging from about 5 wt. % to about 95 wt. % relative an amount of the CO₂ sorbed product, wherein the additive includes Ca₅Al₆O₁₄ and/or Ca₉Al₆O₁₈;
wherein the additive at least partially prevents upon heating of the composition sintering of the CO₂ sorbed/desorbed product and the formation of a crust that minimises or prevents the CO₂ desorbed product and CO₂ from reacting with one another to form the CO₂ sorbed product.

55. The system according to claim 53, wherein the material for the reactor comprises a composition comprising:
a form of calcium that is capable of absorbing or desorbing CO₂ to, respectively, form a CO₂ sorbed product or CO₂ desorbed product;
an additive having a concentration ranging from about 5 wt. % to about 95 wt. % relative an amount of the CO₂ sorbed product, wherein the additive includes a mixture of Zr and Al oxides;
wherein the additive at least partially prevents upon heating of the composition sintering of the CO₂ sorbed/desorbed product and the formation of a crust that minimises or prevents the CO₂ desorbed product and CO₂ from reacting with one another to form the CO₂ sorbed product.
